(19) United States
(12) Patent Application Publication
(10) Pub. No.: US 2013/0083993 A1
(43) Pub. Date: Apr. 4, 2013

(54) IMAGE PROCESSING DEVICE, IMAGE PROCESSING METHOD, AND PROGRAM

(71) Applicant: Yasuhiro Sutou, Tokyo (JP)

(72) Inventor: Yasuhiro Sutou, Tokyo (JP)

(73) Assignee: SONY CORPORATION, Tokyo (JP)

(21) Appl. No.: 13/609,519

(22) Filed: Sep. 11, 2012

(30) Foreign Application Priority Data
Sep. 29, 2011 (JP) 2011-214673

(51) Int. Cl. G06K 9/62

(52) U.S. Cl. 382/154

(57) ABSTRACT

An image processing device includes: an image acquisition section acquiring base and reference images in which a same object is drawn at horizontal positions different from each other; and a disparity detection section detecting a candidate pixel as a candidate of a pixel corresponding to a base pixel constituting the base image, from a reference pixel group including a first reference pixel constituting the reference image, and a second reference pixel, whose vertical position is different from that of the first reference pixel, based on the base pixel and the reference pixel group, associating a horizontal disparity candidate indicating a distance from a horizontal position of the base pixel to a horizontal position of the candidate pixel, with a vertical disparity candidate indicating a distance from a vertical position of the base pixel to a vertical position of the candidate pixel, and storing the associated candidates in a storage section.

### FIELD

The present disclosure relates to an image processing device, an image processing method, and a program.

### BACKGROUND

Naked-eye 3D display apparatuses capable of three-dimensionally displaying an image without using special glasses for three-dimensional viewing have been used. The naked-eye 3D display apparatus acquires a plurality of images in which the same object is drawn at different horizontal positions. Then, the naked-eye 3D display apparatus compares object images, each of which is a part where the object is drawn, with each other, and detects misalignment in the horizontal positions of the object images, that is, horizontal disparity. Subsequently, the naked-eye 3D display apparatus generates a plurality of multi-view images on the basis of the detected horizontal disparity and the acquired images, and three-dimensionally displays such multi-view images. As a method by which the naked-eye 3D display apparatus detects the horizontal disparity, the global matching disclosed in Japanese Patent No. 4410007 has been used.

### SUMMARY

However, in the global matching, in a case where the positions of the object images in the vertical direction are misaligned (geometrically misaligned) from each other, a problem arises in that robustness and accuracy of disparity detection significantly deteriorate. Accordingly, there has been demand for a technique capable of detecting horizontal disparity with high robustness and accuracy.

An embodiment of the present disclosure is directed to an image processing device including: an image acquisition section that acquires a base image and a reference image in which a same object is drawn at horizontal positions different from each other; and a disparity detection section that detects a candidate pixel as a candidate of a correspondence pixel corresponding to a base pixel, which constitutes the base image, from a reference pixel group including a first reference pixel, which constitutes the reference image, and a second reference pixel, whose vertical position is different from that of the first reference pixel, on the basis of the base pixel and the reference pixel group, associates a horizontal disparity candidate, which indicates a distance from a horizontal position of the base pixel to a horizontal position of the candidate pixel, with a vertical disparity candidate, which indicates a distance from a vertical position of the base pixel to a vertical position of the candidate pixel, and stores the associated candidates in a storage section.

Another embodiment of the present disclosure is directed to an image processing method including: acquiring a base image and a reference image in which a same object is drawn at horizontal positions different from each other; detecting a candidate pixel as a candidate of a correspondence pixel corresponding to a base pixel, which constitutes the base image, from a reference pixel group including a first reference pixel, which constitutes the reference image, and a second reference pixel, whose vertical position is different from that of the first reference pixel, on the basis of the base pixel and the reference pixel group, associating a horizontal disparity candidate, which indicates a distance from a horizontal position of the base pixel to a horizontal position of the candidate pixel, with a vertical disparity candidate, which indicates a distance from a vertical position of the base pixel to a vertical position of the candidate pixel, and storing the associated candidates in a storage section.

Still another embodiment of the present disclosure is directed to a program for causing a computer to execute: an image acquisition function that acquires a base image and a reference image in which a same object is drawn at horizontal positions different from each other; and a disparity detection function that detects a candidate pixel as a candidate of a correspondence pixel corresponding to a base pixel, which constitutes the base image, from a reference pixel group including a first reference pixel, which constitutes the reference image, and a second reference pixel, whose vertical position is different from that of the first reference pixel, on the basis of the base pixel and the reference pixel group, associates a horizontal disparity candidate, which indicates a distance from a horizontal position of the base pixel to a horizontal position of the candidate pixel, with a vertical disparity candidate, which indicates a distance from a vertical position of the base pixel to a vertical position of the candidate pixel, and stores the associated candidates in a storage section.

In the embodiments of the present disclosure, the candidate pixel as a candidate of the correspondence pixel is detected from the reference pixel group including the first reference pixel, which constitutes the reference image, and a second reference pixel whose vertical position is different from that of the first reference pixel. In addition, in the embodiments of the present disclosure, the vertical disparity candidate, which indicates the distance from the vertical position of the base pixel to the vertical position of the candidate pixel, is stored in the storage section. As described above, in the embodiments of the present disclosure, the search for the candidate pixel as a candidate of the correspondence pixel is performed in the vertical direction, and the vertical disparity candidate as a result of the search is stored in the storage section.

As described above, in the embodiments of the present disclosure, it is possible to search for the candidate pixel in the vertical direction of the reference image, and thus it is possible to detect the horizontal disparity with high robustness and accuracy.

### BRIEF DESCRIPTION OF THE DRAWINGS

FIG. 1 is a flowchart illustrating a brief overview of processing using the naked-eye 3D display apparatus;

FIGS. 2A and 2B are explanatory diagrams illustrating color misalignment between input images;

FIGS. 3A and 3B are explanatory diagrams illustrating geometric misalignment between input images;

FIG. 4 is an explanatory diagram illustrating a situation in which a disparity map and multi-view images are generated;

FIG. 5 is a block diagram illustrating a configuration of an image processing device according to an embodiment of the present disclosure;

FIG. 6 is a block diagram illustrating a configuration of a first disparity detection section;

FIG. 7 is an explanatory diagram illustrating an example of a vertical disparity candidate storage table;

FIG. 8 is an explanatory diagram illustrating a configuration of a path building portion;

FIG. 9 is a DP map used when disparity matching is performed;

FIG. 10 is a block diagram illustrating a configuration of an evaluation section;

FIG. 11 is a block diagram illustrating a configuration of a neural network processing portion;

FIG. 12 is an explanatory diagram illustrating processing using a marginalization processing portion;

FIG. 13 is an explanatory diagram illustrating an example of a relative reliability map;

FIG. 14 is an explanatory diagram illustrating an example of a classification table;

FIG. 15 is an explanatory diagram illustrating an example of an image classified as Class 0;

FIG. 16 is an explanatory diagram illustrating an example of an image classified as Class 4;

FIG. 17 is an explanatory diagram illustrating an example of an offset correspondence table;

FIG. 18 is a flowchart illustrating a procedure of disparity detection; and

FIG. 19 is an explanatory diagram illustrating situations in which accuracies of disparity maps are improved in accordance with the passage of time.

### DETAILED DESCRIPTION

Hereinafter, referring to the accompanying drawings, the preferred embodiments of the present disclosure will be described in detail. In addition, in the present specification and drawings, if some components have actually the same functional configuration, the components are represented by the same reference numerals and signs, and repeated description thereof will be omitted.

In addition, descriptions will be given in the following order.

1. Brief Overview of Processing Executed by Naked-Eye 3D Display Apparatus

2. Configuration of Image Processing Device

3. Processing Using Image Processing Device

4. Advantages Resulting from Image Processing Device

### <1. Brief Overview of Processing Executed by Naked-Eye 3D Display Apparatus>

As a result of repeated thorough examinations for a naked-eye 3D display apparatus capable of three-dimensionally displaying an image without using special glasses for three-dimensional viewing, the inventors of the present application proposed an image processing device according to the present embodiment. Here, 3D display means that an image is three-dimensionally displayed by causing binocular disparity for a viewer.

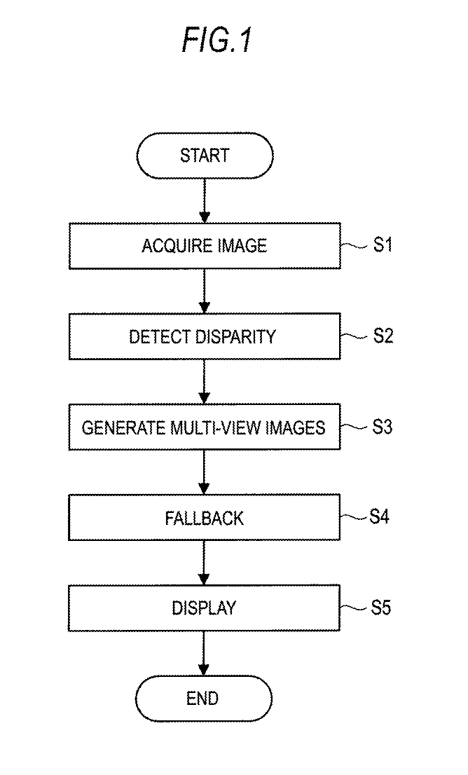

Accordingly, first, a brief overview of processing performed by the naked-eye 3D display apparatus including an image processing device will be given with reference to the flowchart shown in FIG. 1.

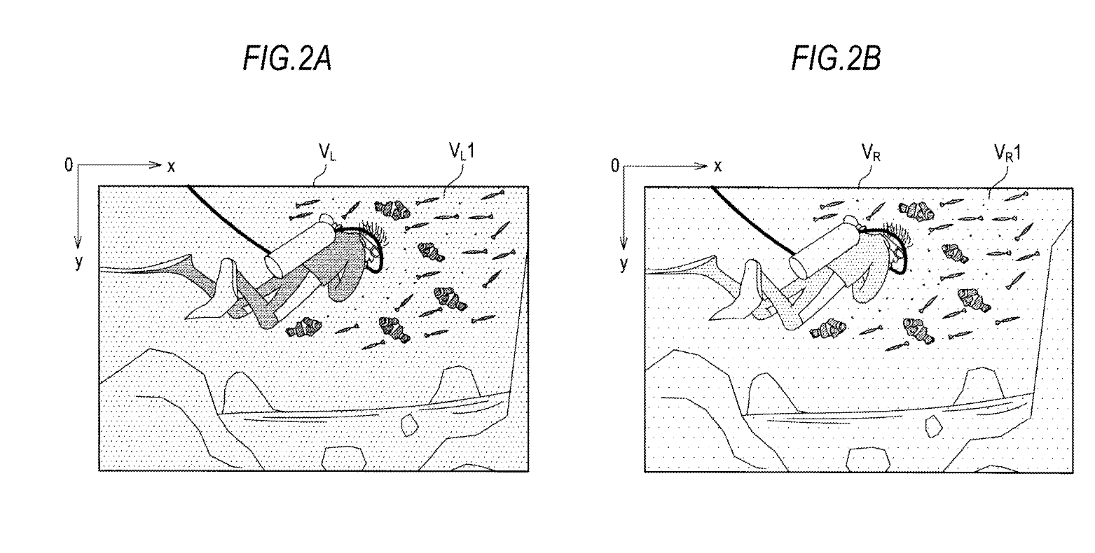

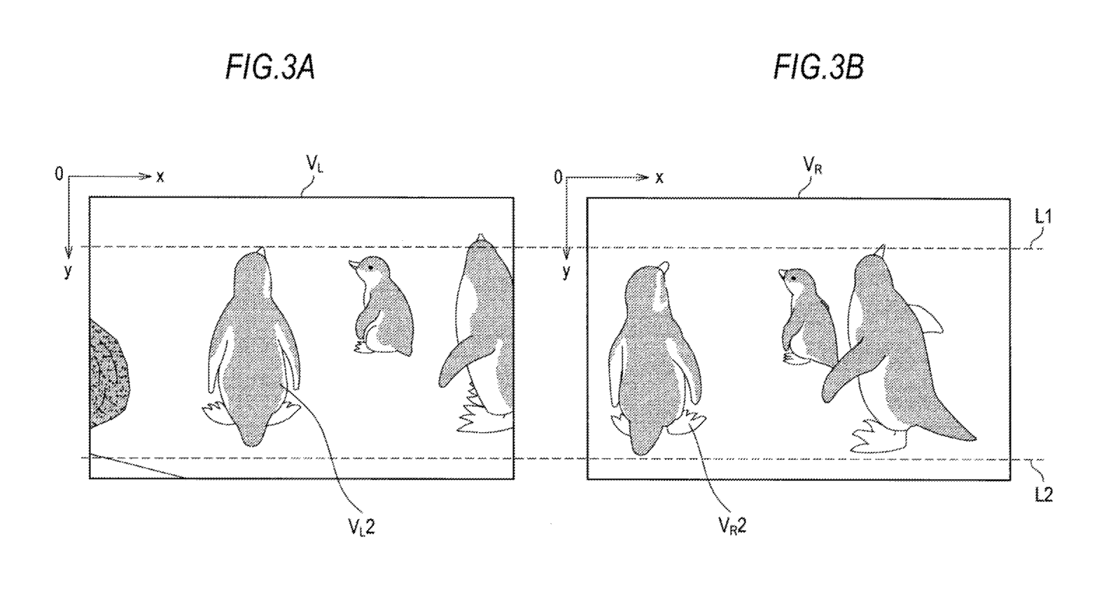

In step S1, the naked-eye 3D display apparatus acquires input images V_{L} and V_{R}. FIGS. 2A, 2B and 3A, 3B show examples of input images V_{L} and V_{R}. In addition, in the present embodiment, the pixels on the upper left ends of the input images V_{L} and V_{R} are set as the origins, the horizontal direction is set as the x axis, and the vertical direction is set as the y axis. The rightward direction is the positive direction of the x axis, and the downward direction is the positive direction of the y axis. Each pixel has coordinate information (x, y) and color information (luminance, chroma, hue). Hereinafter, the pixels on the input image V_{L} are referred to as “left side pixels”, and the pixels on the input image V_{R} are referred to as “right side pixels”. Further, the following description will mostly give an example where the input image V_{L} is set as a base image and the input image V_{R} is set as a reference image. However, it is apparent that the input image V_{L} may be set as a reference image and the input image V_{R} may be set as a base image.

As shown in FIGS. 2A, 2B and 3A, 3B the same objects (for example, sea, fish, and penguins) are drawn at horizontal positions (x coordinates) different from each other in the input images V_{L} and V_{R}.

However, as shown in FIGS. 2A and 2B, there is color misalignment between the input images V_{L} and V_{R}. That is, the object is drawn in different colors between the input image V_{L} and the input image V_{R}. For example, both the object image V_{L}1 and the object image V_{R}1 show the same sea, but colors thereof are different.

On the other hand, as shown in FIGS. 3A and 3B, there is geometric misalignment between the input images V_{L} and V_{R}. That is, the same object is drawn at height positions (y coordinates). For example, both the object image V_{L}2 and the object image V_{R}2 show penguins, but there is a difference between the y coordinate of the object image V_{L}2 and the y coordinate of the object image V_{R}2. In FIGS. 3A and 3B, in order to facilitate understanding of the geometric misalignment, the straight line L1 is drawn. Accordingly, the naked-eye 3D display apparatus detects disparity corresponding to such misalignment. That is, the naked-eye 3D display apparatus is able to precisely detect disparity even without performing calibration for the color misalignment and the geometric misalignment.

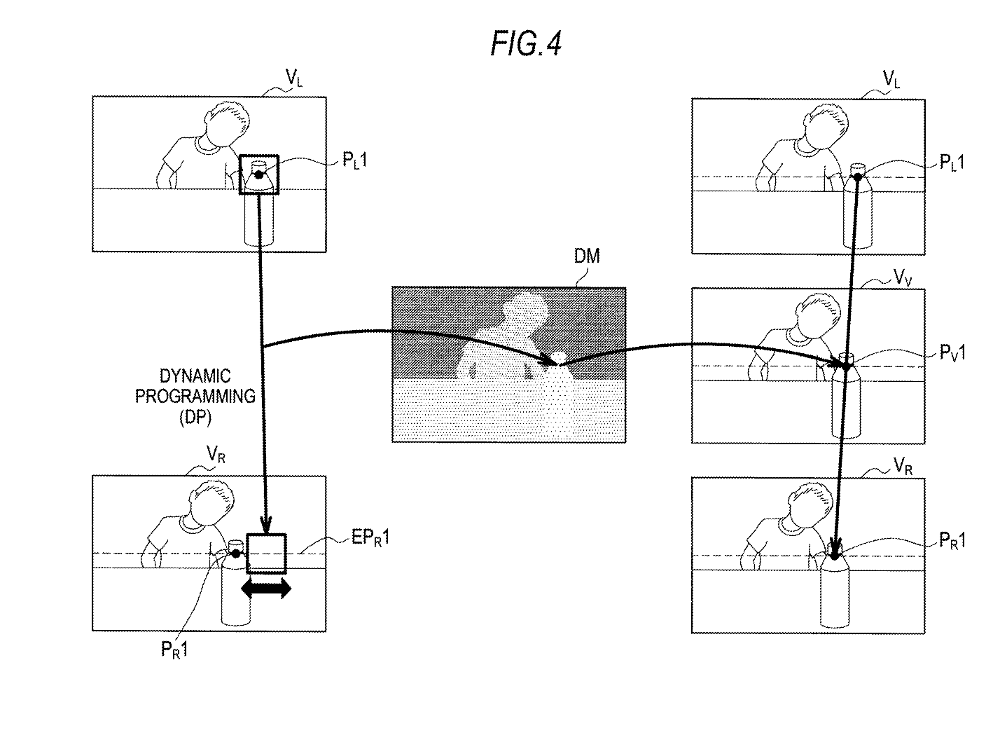

In step S2, the naked-eye 3D display apparatus detects disparity based on of the input images V_{L} and V_{R}. The situation of the disparity detection is shown in FIG. 4.

As shown in FIG. 4, the naked-eye 3D display apparatus extracts a plurality of candidate pixels as candidates of the correspondence pixels corresponding to the left side pixel P_{L}1 from each right side pixel which resides in the epipolar line EP_{R}1 or at a position deviated from the epipolar line EP_{R}1 in the vertical direction (y direction). In addition, the epipolar line EP_{R}1 is a straight line which is drawn on the input image V_{R}, has a y coordinate the same as the left side pixel P_{L}1, and extends in the horizontal direction. Further, the naked-eye 3D display apparatus sets an offset corresponding to the color misalignment of the input images V_{L} and V_{R}, and extracts candidate pixels on the basis of the offset.

Then, the naked-eye 3D display apparatus extracts a right side pixel P_{R}1 as a correspondence pixel from the candidate pixels. The naked-eye 3D display apparatus sets a value, which is obtained by subtracting the x coordinate of the left side pixel P_{L}1 from the x coordinate of the right side pixel P_{R}1, as a horizontal disparity d1, and sets a value, which is obtained by subtracting the y coordinate of the left side pixel P_{L}1 from the y coordinate of the right side pixel P_{R}1, as a vertical disparity d2.

As described above, the naked-eye 3D display apparatus searches for not only the pixels, which have the y coordinate (vertical position) the same as that of the left side pixel, but also the pixels, which have y coordinates different from that of the left side pixel, among the right side pixels constituting the input image V_{R}. Accordingly, the naked-eye 3D display apparatus is able to detect disparity corresponding to the color misalignment and geometric misalignment.

The naked-eye 3D display apparatus detects the horizontal disparity d1 and the vertical disparity d2 from all pixels on the input image V_{L}, thereby generating a global disparity map. Further, the naked-eye 3D display apparatus calculates, as described later, the horizontal disparity d1 and the vertical disparity d2 of the pixels constituting the input image V_{L} by using a method (that is, the local matching) different from the method (that is, the global matching). Then, the naked-eye 3D display apparatus generates a local disparity map on the basis of the horizontal disparity d1 and the vertical disparity d2 calculated by the local matching. Subsequently, the naked-eye 3D display apparatus integrates such disparity maps, thereby generating an integral disparity map. FIG. 4 shows the integral disparity map DM as an example of the integral disparity map. In FIG. 4, the level of the horizontal disparity d1 is indicated by the amount of shading in the hatching.

In step S3, the naked-eye 3D display apparatus generates a plurality of multi-view images V_{V} on the basis of the integral disparity map and the input images V_{L} and V_{R}. For example, the multi-view image V_{V} shown in FIG. 4 is an image which is interpolated between the input image V_{L} and the input image V_{R}. Accordingly, the pixel P_{V}1 corresponding to the left side pixel P_{L}1 resides between the left side pixel P_{L}1 and the right side pixel P_{R}1.

Here, the respective multi-view images V_{V} are images three-dimensionally displayed by the naked-eye 3D display apparatus, and correspond to the respective different points of view (the positions of the viewer's eyes). That is, the respective multi-view images V_{V}, which the viewer's eyes have visual contact with, are different in accordance with the positions of the viewer's eyes. For example, the right eye and the left eye of a viewer are at different positions, and thus have visual contact with the respective multi-view image V_{V}. Thereby, the viewer is able to view the multi-view images V_{V} three-dimensionally. Further, even when the point of view of a viewer is changed by movement of the viewer, if there is a multi-view image V_{V} corresponding to the point of view, the viewer is able to view the multi-view image V_{V} three-dimensionally. As described above, as the number of multi-view images V_{V} increases, a viewer is able to three-dimensionally view multi-view images V_{V} from more positions. Further, as the number of multi-view images V_{V} increases, reverse viewing, that is, a phenomenon in which the multi-view image V_{V} to be originally viewed through the right eye is viewed through the left eye, is unlikely to occur. Furthermore, by generating a plurality of multi-view images V_{V}, motion disparity can be represented.

In step S4, the naked-eye 3D display apparatus performs fallback (refinement). This processing is briefly processing to correct multi-view images V_{V} again in accordance with the content thereof. In step S5, the naked-eye 3D display apparatus three-dimensionally displays the multi-view images V_{V}.

### <2. Configuration of Image Processing Device>

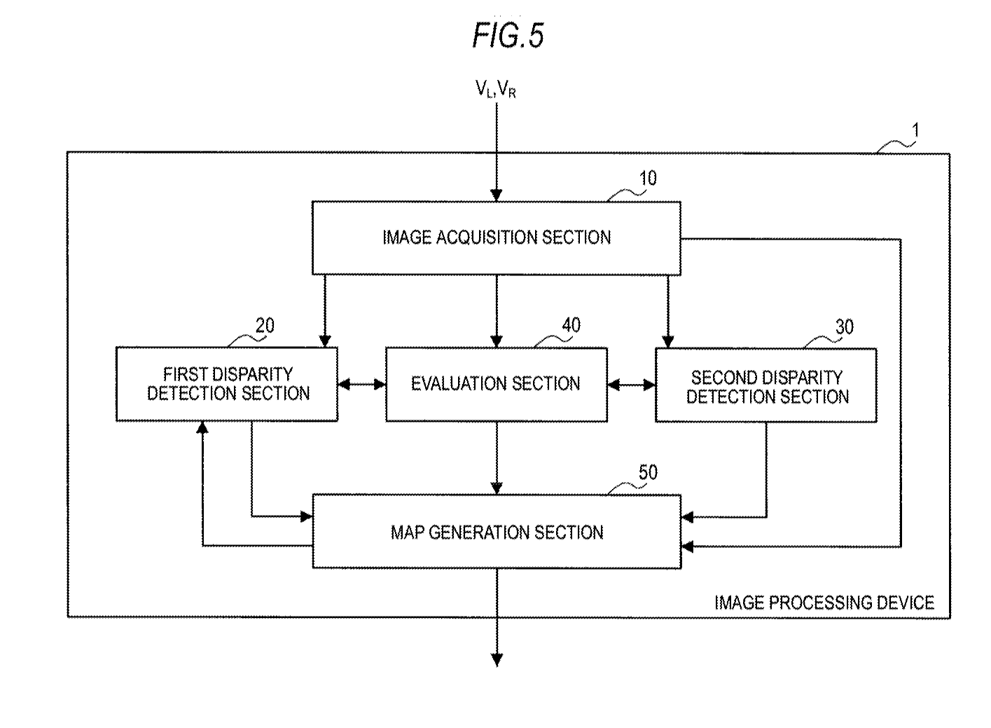

Next, a configuration of an image processing device 1 according to the present embodiment will be described with reference to the accompanying drawings. As shown in FIG. 5, the image processing device 1 includes: an image acquisition section 10; a first disparity detection section 20; a second disparity detection section 30; an evaluation section 40; and a map generation section (offset calculation section) 50. That is, the image processing device 1 has a hardware configuration such as a CPU, a ROM, a RAM, and a hard disk, and the respective components are embodied by such a hardware configuration. That is, in the image processing device 1, the ROM stores programs for implementing the image acquisition section 10, the first disparity detection section 20, the second disparity detection section 30, the evaluation section 40, and the map generation section 50. The image processing device 1 performs processing in steps S1 and S2 mentioned above.

The image processing device 1 performs the following processing. That is, the image acquisition section 10 acquires the input images V_{L} and V_{R}, and outputs them to the respective components of the image processing device 1. The first disparity detection section 20 performs the global matching on the input images V_{L} and V_{R}, thereby detecting the horizontal disparity d1 and the vertical disparity d2 for each of the left side pixels constituting the input image V_{L}. On the other hand, the second disparity detection section 30 performs the local matching on the input images V_{L} and V_{R}, thereby detecting the horizontal disparity d1 and the vertical disparity d2 for each of the left side pixels constituting the input image V_{L}.

That is, the image processing device 1 concurrently performs the global matching and the local matching. Here, the local matching has an advantage in that the degree of accuracy does not depend on qualities (degrees of the color misalignment, the geometric misalignment, and the like) of the input images V_{L} and V_{R}, but also has a disadvantage in occlusion, that is, a disadvantage that stability is poor (the degree of accuracy tends to be uneven). In contrast, the global matching has an advantage in occlusion, that is, an advantage in stability, but also has a disadvantage that the degree of accuracy tends to depend on qualities of the input images V_{L} and V_{R}. Accordingly, the image processing device 1 concurrently performs both matching operations, provides disparity maps obtained from the results thereof, and integrates the maps.

### [Configuration of Image Acquisition Section]

The image acquisition section 10 acquires the input images V_{L} and V_{R}, and outputs them to the respective components in the image processing device 1. The image acquisition section 10 may acquire the input images V_{L} and V_{R} from a memory in the naked-eye 3D display apparatus, and may acquire them through communication with other apparatuses. In addition, in the present embodiment, the “current frame” represents a frame on which processing is currently being performed by the image processing device 1. The “previous frame” represents a frame previous by one frame to the current frame. The “subsequent frame” represents a frame subsequent by one frame to the current frame. When the frame subjected to the processing of the image processing device 1 is not particularly designated, it is assumed that the image processing device 1 is performing processing on the current frame.

### [Configuration of First Disparity Detection Section]

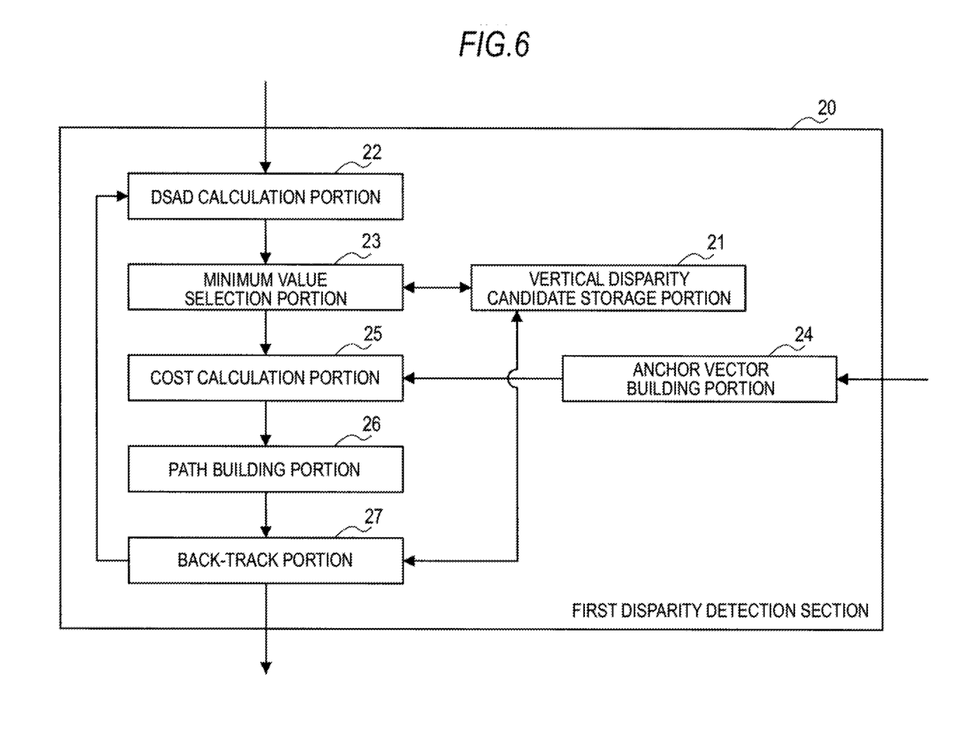

The first disparity detection section 20 includes, as shown in FIG. 6, a vertical disparity candidate storage portion 21; a DSAD (Dynamic Sum of Absolute Difference) calculation portion 22; a minimum value selection portion 23; an anchor vector building portion 24; a cost calculation portion 25; a path building portion 26; and a back-track portion 27.

### [Configuration of Vertical Disparity Candidate Storage Portion]

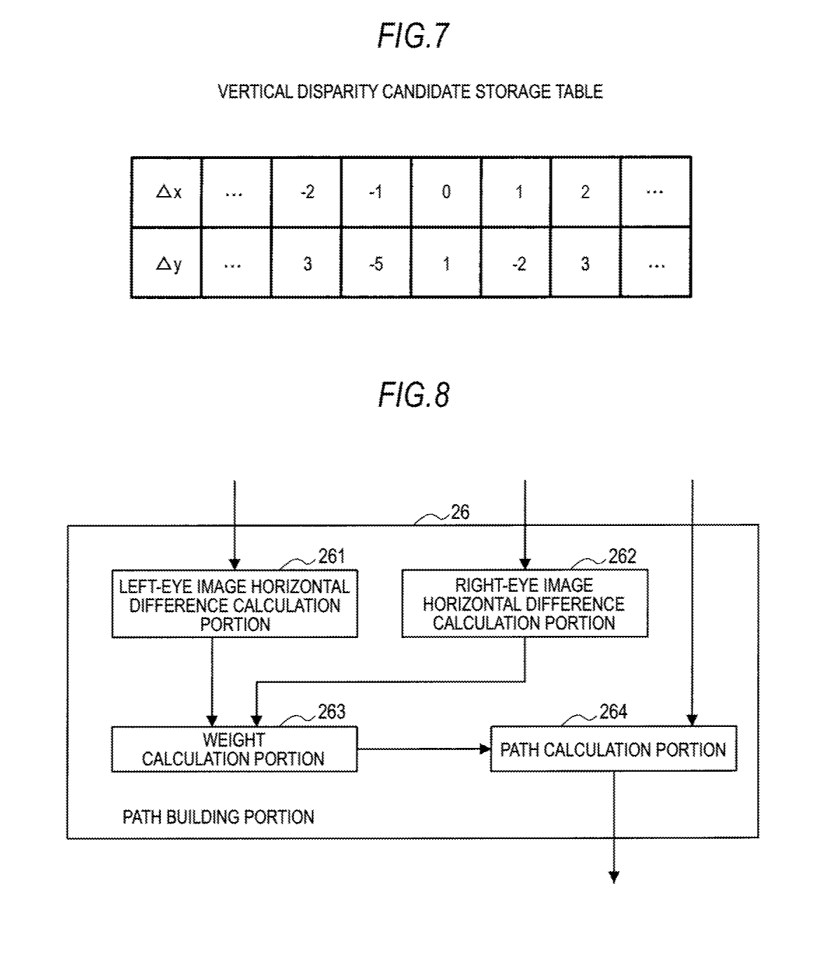

The vertical disparity candidate storage portion 21 stores the vertical disparity candidate storage table shown in FIG. 7. In the vertical disparity candidate storage table, the horizontal disparity candidates Δx and the vertical disparity candidates Δy are associated and recorded. The horizontal disparity candidate Δx indicates a value which is obtained by subtracting the x coordinate of the left side pixel from the x coordinate of the candidate pixel. On the other hand, the vertical disparity candidate Δy indicates a value which is obtained by subtracting the y coordinate of the left side pixel from the y coordinate of the candidate pixel. Detailed description thereof will be given later. The vertical disparity candidate storage table is provided for each left side pixel.

### [Configuration of DSAD Calculation Portion]

The DSAD calculation portion 22 acquires offset information on an offset α1 from the map generation section 50. Here, briefly, since the offset α1 is set depending on the degree of color misalignment between the input image V_{L} and the input image V_{R} of the previous frame, as the color misalignment increases, the offset α1 decreases. In addition, when unable to acquire the offset information (for example, when performing processing on the first frame (0th frame)), the DSAD calculation portion 22 sets the offset α1 to 0.

The DSAD calculation portion 22 sets any one of the left side pixels as a base pixel, and acquires a global disparity map of the previous frame from the back-track portion 27. Then, the DSAD calculation portion 22 searches the global disparity map of the previous frame for the horizontal disparity d1 and the vertical disparity d2 of the previous frame of the base pixel. Subsequently, the DSAD calculation portion 22 sets any one of the right side pixels, which has the vertical disparity d2 of the previous frame relative to the base pixel, as a first reference pixel. That is, the DSAD calculation portion 22 sets any one of the right side pixels, which has the y coordinate obtained by adding the vertical disparity d2 of the previous frame to the y coordinate of the base pixel, as a first reference pixel. As described above, the DSAD calculation portion 22 determines the first reference pixel on the basis of the global disparity map of the previous frame. That is, the DSAD calculation portion 22 performs recursive processing. In addition, when unable to acquire the global disparity map of the previous frame, the DSAD calculation portion 22 sets the right side pixel, which has the same y coordinate as the base pixel, as the first reference pixel.

Then the DSAD calculation portion 22 sets the right side pixels, which reside in a predetermined range from the first reference pixel in the y direction, as second reference pixels. The predetermined range is, for example, a range of ±1 centered on the y coordinate of the first reference pixel, but the range is arbitrarily changed in accordance with balance between robustness and accuracy. A pixel group formed of the first reference pixel and the second reference pixels constitutes a reference pixel group.

As described above, the y coordinate of the first reference pixel is sequentially updated as the frame advances, the pixel which is most reliable (closest to the base pixel) is selected as the first reference pixel. Further, since the reference pixel group is set on the basis of the updated first reference pixel, the searching range in the y direction is practically increased. For example, when the y coordinate of the first reference pixel is set to 5 at the 0th frame, the y coordinates of the second reference pixels are respectively set to 4 and 6. Thereafter, when the y coordinate of the first reference pixel is updated to 6 in the first frame, the y coordinates of the second reference pixels are respectively set to 5 and 7. In this case, the y coordinate of the first reference pixel is set to 5 at the 0th frame, while the y coordinate of the second reference pixel increases up to 7 as the frame advances from the 0th frame to the first frame. That is, the searching range in the y direction is practically increased by 1 in the positive direction thereof. Thereby, the image processing device 1 is able to perform disparity detection that is less affected by geometric misalignment. In addition, when determining the first reference pixel, the DSAD calculation portion 22 uses the global disparity map of the previous frame, but may use the integral disparity map of the previous frame. In this case, the DSAD calculation portion 22 may more accurately determine the first reference pixel.

On the basis of the base pixel, the reference pixel group including the first reference pixel and the second reference pixels, and the offset α1, the DSAD calculation portion 22 calculates the DSAD(Δx, j) (a first evaluation value, a second evaluation value) which is represented by the following Expression (1).

$$DSAD ( Δ x , j ) = {\sum }_{i} \vert ( L ( i ) - R ( i , j ) ) - ( L ( 0 ) - R ( 0 , j ) ) \times ( 1 - α 1 ) \vert \qquad ( 1 )$$

Here, the Δx is a value which is obtained by subtracting the x coordinate of the base pixel from the x coordinate of the first reference pixel. In addition, as described later, the minimum DSAD(Δx, j) is selected for each Δx, and the right side pixel corresponding to the minimum DSAD(Δx, j) is set as a candidate pixel. Accordingly, the Δx is also a value which is obtained by subtracting the x coordinate of the base pixel from the x coordinate of the candidate pixel, that is, the horizontal disparity candidate. The j is an integer in the range of −1 to +1, and the i is an integer in the range of −2 to 2. L(i) is a luminance of the left side pixel whose y coordinate is different by i from that of the base pixel. That is, L(i) indicates a base pixel feature amount in a base region centered on the base pixel. The R(i, 0) indicates a first reference pixel feature amount in a first reference region centered on the first reference pixel. Accordingly, the DSAD(Δx, 0) indicates an evaluation value of a difference between the base pixel feature amount and the first reference pixel feature amount, that is, the first evaluation value.

Meanwhile, the R(i, 1) and R(i, −1) indicate first reference pixel feature amounts in second reference regions centered on the second reference pixels. Accordingly, the DSAD(Δx, 1) and DSAD(Δx, −1) indicate evaluation values of differences between the base pixel feature amount and the second reference pixel feature amounts, that is, the second evaluation values. The α is the above-mentioned offset.

Accordingly, the DSAD calculation portion 22 calculates the DSAD by reference to not only the luminances of the base pixel, the first reference pixel, and the second reference pixels, but also the luminance of the pixel which is deviated from such a pixel in the y direction. That is, the DSAD calculation portion 22 causes the y coordinates of the base pixel, the first reference pixel, and the second reference pixels, to fluctuate thereby referring to the ambient luminances of the pixels. Accordingly, in this respect, the image processing device 1 is able to perform disparity detection that is less affected by geometric misalignment. Note that, in the processing, an amount of fluctuation of the y coordinate is set as two pixels in up and down directions relative to the y coordinate of each pixel, but this range is arbitrarily changed in accordance with the balance between robustness and accuracy. Further, since the DSAD calculation portion 22 uses the offset corresponding to the color misalignment in calculating the DSAD, it is possible to perform disparity detection less affected by color misalignment.

The DSAD calculation portion 22 calculates the DSAD(Δx, j) for every horizontal disparity candidate Δx. That is, the DSAD calculation portion 22 generates the reference pixel group for each first reference pixel whose horizontal position is different, and calculates the DSAD(Δx, j) for each reference pixel group. Then, the DSAD calculation portion 22 changes the base pixel, and repeats the processing. Thereby, the DSAD calculation portion 22 calculates the DSAD(Δx, j) for every base pixel. Subsequently, the DSAD calculation portion generates DSAD information in which each base pixel is associated with each DSAD(Δx, j), and outputs the information to the minimum value selection portion 23.

### [Configuration of Minimum Value Selection Portion]

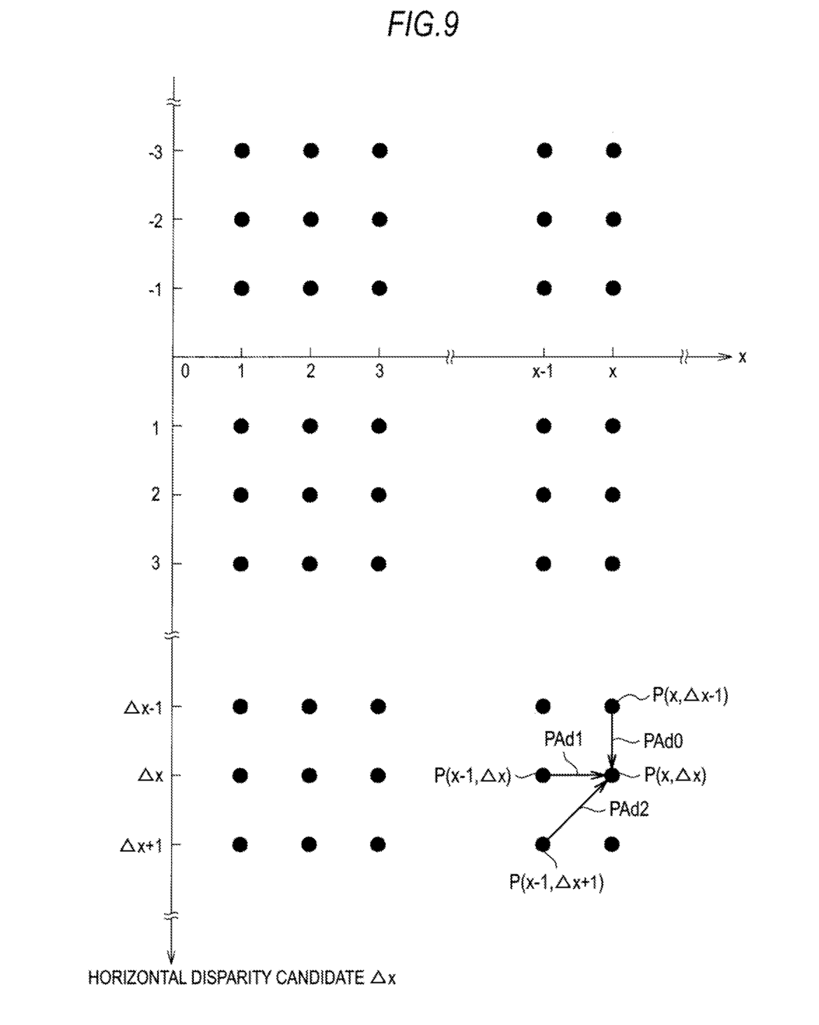

The minimum value selection portion 23 performs the following processing, on the basis of the DSAD information. That is, the minimum value selection portion 23 selects the minimum DSAD(Δx, j) for each horizontal disparity candidate Δx. The minimum value selection portion 23 stores the selected DSAD(Δx, j) in each node P (x, Δx) of the DP map for disparity detection shown in FIG. 9. Accordingly, the minimum DSAD(Δx, j) is set as a score of the node P (x, Δx).

In the DP map for disparity detection, the horizontal axis is set as the x coordinate of the left side pixel, the vertical axis is set as the horizontal disparity candidate Δx, and a plurality of nodes P (x, Δx) are provided. The DP map for disparity detection is used when the horizontal disparity d1 of the left side pixel is calculated. Further, the DP map for disparity detection is generated for each y coordinate of the left side pixels. Accordingly, any one of nodes P (x, Δx) in any one of the DP maps for disparity detection corresponds to any one of the left side pixels.

Furthermore, the minimum value selection portion 23 specifies the reference pixel, corresponding to the minimum DSAD(Δx, j), as a candidate pixel. Then, the minimum value selection portion 23 sets a value, which is obtained by subtracting the y coordinate of the base pixel from the y coordinate of the candidate pixel, as the vertical disparity candidate Δy. Subsequently, the minimum value selection portion 23 associates the horizontal disparity candidate Δx with the vertical disparity candidate Δy, and stores them in the vertical disparity candidate storage table. The minimum value selection portion 23 performs the processing for every base pixel.

### [Configuration of Anchor Vector Building Portion]

The anchor vector building portion 24 shown in FIG. 6 acquires the time reliability map of the previous frame from the evaluation section 40, and acquires the integral disparity map of the previous frame from the map generation section 50. The time reliability map of the current frame is a map that indicates whether or not the horizontal disparity d1 and the vertical disparity d2 of the left side pixel, indicated by the integral disparity map of the current frame, can be used as references even in the subsequent frame. Accordingly, the time reliability map of the previous frame indicates whether or not the horizontal disparity d1 and the vertical disparity d2, detected in the previous frame, can be used as references even in the current frame, for each left side pixel. The anchor vector building portion 24 specifies, on the basis of the time reliability map of the previous frame, a left side pixel for which the horizontal disparity d1 and the vertical disparity d2 can be used as references in the current frame, that is, a disparity stabilization left side pixel. Then, the anchor vector building portion 24 specifies, on the basis of the integral disparity map of the previous frame, the horizontal disparity d1 of the disparity stabilization left side pixel in the previous frame, that is, a stable horizontal disparity d1′. Subsequently, the anchor vector building portion 24 generates, for each disparity stabilization left side pixel, an anchor vector which is represented by the following Expression (2).

Anchor=α2×(0 . . . 10 . . . 0)=α2×M_{d} (2)

Here, the α2 indicates a bonus value, the matrix M_{d} indicates the horizontal disparity d1 of the disparity stabilization left side pixel in the previous frame. That is, the respective columns of the matrix M_{d} indicate the respective different horizontal disparity candidates Δx, and the column, the element of which is 1, indicates that the vertical disparity candidate Δx corresponding to the column is the stable horizontal disparity d1′. If there is no disparity stabilization left side pixel, all elements of the matrix M_{d} are 0. In addition, when unable to acquire the time reliability map and the integral disparity map of the previous frame (for example, when performing processing on the 0th frame), the anchor vector building portion 24 sets all elements of the matrix M_{d} to 0. The anchor vector building portion 24 generates anchor vector information in which the anchor vectors are associated with the disparity stabilization left side pixels, and outputs the information to the cost calculation portion 25.

### [Configuration of Cost Calculation Portion]

The cost calculation portion 25 shown in FIG. 6 updates a value of each node P (x, d) of the DP map for disparity detection, on the basis of the anchor vector information. That is, the cost calculation portion 25 specifies a node (x, Δx (=d1′)) corresponding to the stable horizontal disparity d1′ for each disparity stabilization left side pixel, and subtracts the bonus value α2 from the score of the node. Thereby, the nodes, each of which has a disparity equal to the stable horizontal disparity d1′, tend to be in the shortest path. In other words, the stable horizontal disparity d1′ tends to be selected in the current frame.

### [Configuration of Path Building Portion]

The path building portion 26 shown in FIG. 6 includes, as shown in FIG. 8: a left-eye image horizontal difference calculation portion 261; a right-eye image horizontal difference calculation portion 262; a weight calculation portion 263; and a path calculation portion 264.

The left-eye image horizontal difference calculation portion 261 acquires the input image V_{L} from the image acquisition section 10, and performs the following processing for each left side pixel constituting the input image V_{L}. That is, the left-eye image horizontal difference calculation portion 261 sets any one of the left side pixels as a base pixel, and subtracts the luminance of the left side pixel, x coordinate of which is larger by 1 than that of the base pixel, from the luminance of the base pixel. The left-eye image horizontal difference calculation portion 261 sets the value, which is obtained in the above-mentioned manner, as a luminance horizontal difference dw_{L}, and generates luminance horizontal difference information based on the luminance horizontal difference dw_{L}. Then, the left-eye image horizontal difference calculation portion 261 outputs the luminance horizontal difference information to the weight calculation portion 263.

The right-eye image horizontal difference calculation portion 262 acquires the input image V_{R} from the image acquisition section 10. Then, the right-eye image horizontal difference calculation portion 262 performs the same processing as the above-mentioned left-eye image horizontal difference calculation portion 261 on the input image V_{R}. Subsequently, the right-eye image horizontal difference calculation portion 262 outputs the luminance horizontal difference information, which is generated through the processing, to the weight calculation portion 263.

The weight calculation portion 263 calculates a weight wt_{L} of the left side pixel and a weight wt_{R} of the right side pixel for every left side pixel and right side pixel, on the basis of the luminance horizontal difference information. Specifically, the weight calculation portion 263 substitutes the luminance horizontal difference dw_{L} of the left side pixel into a sigmoidal function, thereby normalizing the luminance horizontal difference dw_{L} to a value of 0 to 1, and sets the value as the weight wt_{L}. Likewise, the weight calculation portion 263 substitutes the luminance horizontal difference dw_{R} of the right side pixel into the sigmoidal function, thereby normalizing the luminance horizontal difference dw_{R} to a value of 0 to 1, and sets the value as the weight wt_{R}. Then, the weight calculation portion 263 generates weight information based on the calculated weights wt_{L} and wt_{R}, and outputs the information to the path calculation portion 264. The weights wt_{L} and wt_{R} decrease at the portions of the edges (contours) of the images, and increase at planar portions thereof. In addition, the sigmoidal function is given by, for example, the following Expression the following Expression (2-1).

$$f ( x ) = \frac{1}{1 + {e}^{- kx}} \qquad ( 2 \text{-} 1 )$$

Here, the k represents gain.

The path calculation portion 264 calculates an accumulated cost, which is accumulated from the start point of the DP map for disparity detection to each node P (x, Δx), on the basis of the weight information given by the weight calculation portion 263. Specifically, the path calculation portion 264 sets the node (0, 0) as a start point, and sets the node (xₘₐₓ, 0) as an end point. Thereby, the accumulated cost, which is accumulated from the start point to the node P (x, Δx), is defined below. Here, the xₘₐₓ is a maximum value of the x coordinate of the left side pixel.

DFI(x,Δx)₀=DFI(x,Δx−1)+occCost₀+occCost₁×wt_{R} (3)

DFI(x,Δx)₀=DFI(x−1,Δx)+DFD(x,d) (4)

DFI(x,Δx)₂=DFI(x−1,Δx+1)+occCost₀+occCost₂×wt_{L} (5)

Here, the DFI(x, Δx)₀ is an accumulated cost which is accumulated through the path PA_{d}0 to the node P (x, Δx), the DFI(x, Δx)₁ is an accumulated cost which is accumulated through the path PA_{d}1 to the node P (x, Δx), and the DFI(x, Δx)₂ is an accumulated cost which is accumulated through the path PA_{d}2 to the node P (x, Δx). Further, the DFI(x, Δx−1) is an accumulated cost which is accumulated from the start point to the node P (x, Δx−1). The DFI(x−1, Δx) is an accumulated cost which is accumulated from the start point to the node P (x−1, Δx). The DFI(x−1, Δx+1) is an accumulated cost which is accumulated from the start point to the node P (x−1, Δx+1). Further, the occCost₀ and the occCost₁ are respectively predetermined values which indicate values of costs, and are set to, for example, 4.0. The wt_{L} is a weight of the left side pixel corresponding to the node P (x, Δx), and the wt_{R} is a weight of the right side pixel which has the same coordinates as the left side pixel.

Then, the path calculation portion 264 selects the minimum of the accumulated costs DFI(x, Δx)₀ to DFI(x, Δx)₂ which are calculated, and sets the selected one to the accumulated cost DFI(x, Δx) of the node P (x, Δx). The path calculation portion 264 calculates the accumulated cost DFI(x, Δx) for every node P (x, Δx), and stores the cost in the DP map for disparity detection.

The back-track portion 27 reverse tracks a path, by which the accumulated cost is minimized, from the end point toward the start point, thereby calculating the path by which the cost accumulated from the start point to the end point is minimized. The node in the shortest path is the horizontal disparity d1 of the left side pixel corresponding to the node. Accordingly, the back-track portion 27 detects the respective horizontal disparities d1 of the left side pixels by calculating the shortest path.

The back-track portion 27 acquires the vertical disparity candidate storage table corresponding to any one of the left side pixels from the vertical disparity candidate storage portion 21. The back-track portion 27 specifies the vertical disparity candidate Δy corresponding to the horizontal disparity d1 of the left side pixel on the basis of the acquired vertical disparity candidate storage table, and sets the specified vertical disparity candidate Δy as the vertical disparity d2 of the left side pixel. Thereby, the back-track portion 27 detects the vertical disparity d2. Then, the back-track portion 27 detects the vertical disparity d2 for every left side pixel, and generates the global disparity map on the basis of the detected horizontal disparity d1 and vertical disparity d2. The global disparity map indicates the horizontal disparity d1 and the vertical disparity d2 for each left side pixel. The back-track portion outputs the generated global disparity map to the DSAD calculation portion 22, and the evaluation section 40 and the map generation section 50 which are shown in FIG. 5. The global disparity map, which is output to the DSAD calculation portion 22, is used in the subsequent frame.

### [Configuration of Second Disparity Detection Section]

The second disparity detection section 30 shown in FIG. 5 calculates the horizontal disparity d1 and the vertical disparity d2 of each left side pixel by using a method different from that of the first disparity detection section, that is, the local matching. Specifically, the second disparity detection section 30 performs the following processing. The second disparity detection section 30 acquires the input images V_{L} and V_{R} from the image acquisition section 10. Further, the second disparity detection section acquires the time reliability map of the previous frame from the evaluation section 40, and acquires the integral disparity map of the previous frame from the map generation section 50.

The second disparity detection section 30 specifies, on the basis of the time reliability map of the previous frame, a left side pixel for which the horizontal disparity d1 and the vertical disparity d2 can be used as references in the current frame, that is, a disparity stabilization left side pixel. Then, the second disparity detection section 30 specifies, on the basis of the integral disparity map of the previous frame, the horizontal disparity d1 and the vertical disparity d2 of the disparity stabilization left side pixel in the previous frame, that is, a stable horizontal disparity d1′ and a stable vertical disparity d2′. Subsequently, the anchor vector building portion 24 respectively adds the stable horizontal disparity d1′ and the stable vertical disparity d2′ to the xy coordinates of the disparity stabilization left side pixel, and sets the right side pixel having the xy coordinates, which is obtained in this manner, as the disparity stabilization right side pixel.

Further, the second disparity detection section 30 divides each of the input images V_{L} and V_{R} into a plurality of pixel blocks. For example, the second disparity detection section 30 divides the input image V_{L} into 64 left side pixel blocks, and divides the input image V_{R} into 64 right side pixel blocks.

Subsequently, the second disparity detection section 30 detects the correspondence pixels corresponding to the respective left side pixels in each left side pixel block, from the right side pixel block corresponding to each left side pixel block. For example, the second disparity detection section 30 detects the right side pixel, whose luminance is closest to that of each left side pixel, as the correspondence pixel. Here, when intending to detect the correspondence pixel corresponding to the disparity stabilization left side pixel, the second disparity detection section 30 preferentially detects the disparity stabilization right side pixel as the correspondence pixel. For example, when the right side pixel whose luminance is closest to that of each left side pixel is set as the disparity stabilization right side pixel, the second disparity detection section 30 detects the disparity stabilization right side pixel as the correspondence pixel. On the other hand, when the right side pixel, whose luminance is closest to that of each left side pixel, is set as the right side pixel other than the disparity stabilization right side pixel, the second disparity detection section 30 compares a predetermined luminance range with a luminance difference between the right side pixel and the disparity stabilization left side pixel. If the luminance difference is in the predetermined luminance range, the second disparity detection section 30 detects the corresponding right side pixel as the correspondence pixel. If the luminance difference is outside the predetermined luminance range, the second disparity detection section 30 detects the disparity stabilization right side pixel as the correspondence pixel.

The second disparity detection section 30 sets a value, which is obtained by subtracting the x coordinate of the left side pixel from the x coordinate of the correspondence pixel, as the horizontal disparity d1 of the left side pixel, and sets a value, which is obtained by subtracting the y coordinate of the left side pixel from the y coordinate of the correspondence pixel, as the vertical disparity d2 of the right side pixel. The second disparity detection section 30 generates the local disparity map on the basis of the detection result. The local disparity map indicates the horizontal disparity d1 and the vertical disparity d2 for each left side pixel. The second disparity detection section 30 outputs the generated local disparity map to the evaluation section 40 and the map generation section 50.

In addition, when unable to acquire the time reliability map and the integral disparity map of the previous frame (for example, when performing processing on the 0th frame), the second disparity detection section 30 does not detect the disparity stabilization left side pixel, but performs the above-mentioned processing. Further, by performing the same processing as the above-mentioned first disparity detection section 20 for each left side pixel block, the second disparity detection section 30 may detect the horizontal disparity d1 and the vertical disparity d2 of the left side pixel.

### [Configuration of Evaluation Section]

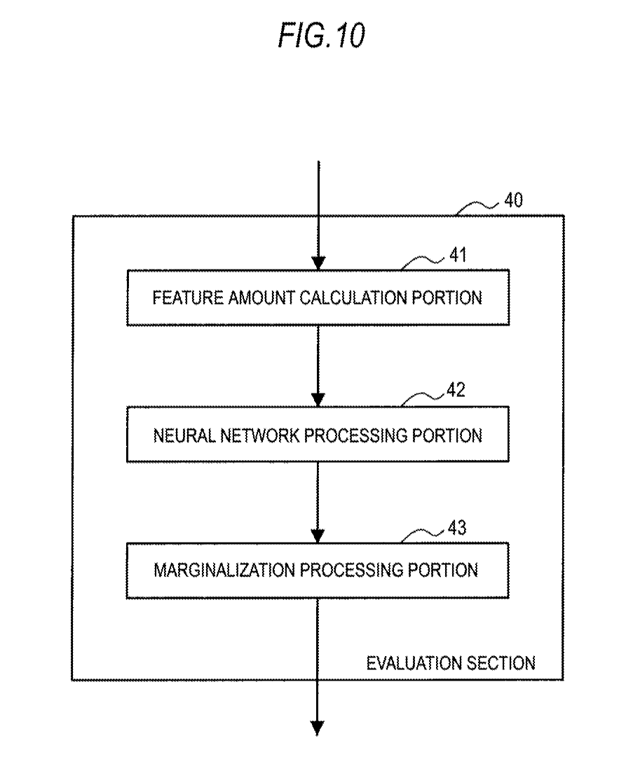

The evaluation section 40 includes, as shown in FIG. 10, a feature amount calculation portion 41, a neural network processing portion 42, and a marginalization processing portion 43.

### [Configuration of Feature Amount Calculation Portion]

The feature amount calculation portion 41 generates various types of feature amount maps (arithmetic feature amounts) on the basis of the disparity map and the like given by the first disparity detection section 20 and the second disparity detection section 30. For example, the feature amount calculation portion 41 generates a local occlusion map on the basis of the local disparity map. Here, the local occlusion map indicates local occlusion information for each left side pixel. The local occlusion information indicates a distance from an arbitrary base position (for example, a position of a photographing device that takes an image of an object) to the object which is drawn by the left side pixels.

Likewise, the feature amount calculation portion 41 generates a global occlusion map on the basis of the global disparity map. The global occlusion map indicates global occlusion information for each left side pixel. The global occlusion information indicates a distance from an arbitrary base position (for example, a position of a photographing device that takes an image of an object) to the object which is drawn by the left side pixels. Further, the feature amount calculation portion 41 generates an absolute occlusion map on the basis of the local occlusion map and the global occlusion map. The absolute occlusion map indicates the absolute occlusion information for each left side pixel. The absolute occlusion information indicates absolute values of the difference values between the local occlusion information and the global occlusion information.

Further, the feature amount calculation portion 41 generates an absolute disparity map. The absolute disparity map indicates an absolute value of the horizontal disparity difference for each left side pixel. Here, the horizontal disparity difference is a value which is obtained by subtracting the horizontal disparity d1 of the local disparity map from the horizontal disparity d1 of the global disparity map.

Furthermore, the feature amount calculation portion 41 generates a local SAD (Sum of Absolute Difference) map on the basis of the local disparity map and the input images V_{L} and V_{R} given by the image acquisition section 10. The local SAD map indicates a local SAD for each left side pixel. The local SAD is a value which is obtained by subtracting the luminance of the left side pixel from the luminance of the correspondence pixel. The correspondence pixel is the right side pixel with the x coordinate, which is the sum of the x coordinate of the left side pixel and the horizontal disparity d1 indicated by the local disparity map, and the y coordinate which is the sum of the y coordinate of the left side pixel and the vertical disparity d2 indicated by the local disparity map.

Likewise, the feature amount calculation portion 41 generates a global SAD (Sum of Absolute Difference) map on the basis of the global disparity map and the input images V_{L} and V_{R} given by the image acquisition section 10. The global SAD map indicates a global SAD for each left side pixel. The global SAD is a value which is obtained by subtracting the luminance of the left side pixel from the luminance of the correspondence pixel. The correspondence pixel is the right side pixel with the x coordinate, which is the sum of the x coordinate of the left side pixel and the horizontal disparity d1 indicated by the global disparity map, and the y coordinate which is the sum of the y coordinate of the left side pixel and the vertical disparity d2 indicated by the global disparity map.

Then, the feature amount calculation portion 41 generates an absolute SAD map on the basis of the local SAD map and the global SAD map. The absolute SAD map indicates the absolute SAD for each left side pixel. The absolute SAD indicates an absolute value of the value which is obtained by subtracting the global SAD from the local SAD.

Further, the feature amount calculation portion 41 calculates an arithmetic mean between the horizontal disparity d1, indicated by the global disparity map, and the horizontal disparity d1, indicated by the local disparity map, thereby generating a mean disparity map. The mean disparity map indicates the arithmetic mean value for each left side pixel.

Furthermore, the feature amount calculation portion calculates a variance (a variance relative to the arithmetic mean value) of the horizontal disparity d1 indicated by the global disparity map for each left side pixel, thereby generating a variance disparity map. The feature amount calculation portion 41 outputs the feature amount map to the neural network processing portion 42. In addition, it is preferable that the feature amount calculation portion 41 generate at least two or more feature amount maps.

### [Neural Network Processing Portion]

The neural network processing portion 42 sets the feature amount map to input values In0 to In(m−1) of the neural network, thereby acquiring output values Out0 to Out2. Here, m is an integer of 2 or more and 11 or less.

Specifically, the neural network processing portion sets any left side pixel, of the left side pixels constituting each feature amount map, as an evaluation target pixel, and acquires a value corresponding to the evaluation target pixel from each feature amount map. Then the neural network processing portion 42 sets such a value as an input value.

The output value Out0 indicates whether or not the horizontal disparity d1 and the vertical disparity d2 of the evaluation target pixel, indicated by the integral disparity map, can be used as references even in the subsequent frame. That is, the output value Out0 indicates time reliability. The output value Out0 is set to, specifically, “0” or “1”. The “0” indicates that, for example, the horizontal disparity d1 and the vertical disparity d2 are not used as references in the subsequent frame. The “1” indicates that, for example, the horizontal disparity d1 and the vertical disparity d2 can be used as references in the subsequent frame.

The output value Out1 indicates which is more reliable between the horizontal and vertical disparities d1 and d2 of the evaluation target pixel indicated by the global disparity map and the horizontal and vertical disparities d1 and d2 of the evaluation target pixel indicated by the local disparity map. That is, the output value Out1 indicates relative reliability. The output value Out1 is set to, specifically, “0” or “1”. The “0” indicates that, for example, the local disparity map has higher reliability than the global disparity map. The “1” indicates that, for example, the global disparity map has higher reliability than the local disparity map.

The output value Out2 is not particularly limited, and may be, for example, information available for various applications. More specifically, the output value Out2 may be the occlusion information of the evaluation target pixel. The occlusion information of the evaluation target pixel indicates a distance from an arbitrary base position (for example, a position of a photographing device that takes an image of an object) to the object which is drawn by the evaluation target pixels, and the information can be used when the naked-eye 3D display apparatus generates the multi-view images. Further, the output value Out2 may be motion information of the evaluation target pixel. The motion information of the evaluation target pixel is information (for example, vector information which indicates the magnitude and the direction of the motion) on the motion of the object which is drawn by the evaluation target pixels. The motion information can be used in 2D3D conversion applications. Further, the output value Out2 may be the luminance changeover information of the evaluation target pixel. The luminance changeover information of the evaluation target pixel is information which indicates which luminance the evaluation target pixel is indicated by, and the information can be used in dynamic range applications.

Further, the output value Out2 may be various kinds of reliability information available at the time of generation of the multi-view images. For example, the output value Out2 may be reliability information which indicates whether or not the horizontal disparity d1 and the vertical disparity d2 of the evaluation target pixel can be used as references at the time of generation of the multi-view images. When unable to use the horizontal disparity d1 and the vertical disparity d2 of the evaluation target pixel as references, the naked-eye 3D display apparatus performs interpolation on the horizontal disparity d1 and the vertical disparity d2 of the evaluation target pixel by using the horizontal disparities d1 and the vertical disparities d2 of the ambient pixels of the evaluation target pixel. Further, the output value Out2 may be reliability information which indicates whether or not the luminance of the evaluation target pixel can be increased at the time of refinement of the multi-view images. The naked-eye 3D display apparatus increases the luminances, which can be further increased, among the luminances of the respective pixels, thereby performing the refinement.

The neural network processing portion 42 generates new input values In0 to In(m−1) by sequentially changing the evaluation target pixel, and acquires the output values Out0 to Out2. Accordingly, the output value Out0 is given as time reliability for each of a plurality of left side pixels, that is, the time reliability map. The output value Out1 is given as relative reliability for each of the plurality of left side pixels, that is, a relative reliability map. The output value Out2 is given as various kinds of information for each of the plurality of left side pixels, that is, an information map. The neural network processing portion 42 outputs such maps to the marginalization processing portion 43. FIG. 13 shows a relative reliability map EM1 as an example of the relative reliability map. The region EM11 indicates a region in which the global disparity map has higher reliability than the local disparity map. The region EM12 indicates a region the local disparity map has higher reliability than the global disparity map.

As described above, the local matching has an advantage that the accuracy does not depend on qualities (degrees of the color misalignment, the geometric misalignment, and the like) of the input images V_{L} and V_{R}, but also has a disadvantage in occlusion, that is, a disadvantage that stability is poor (the degree of accuracy tends to be uneven). In contrast, the global matching has an advantage in occlusion, that is, an advantage in stability, but also has a disadvantage that the degree of accuracy tends to depend on qualities of the input images V_{L} and V_{R}. However, the first disparity detection section 20 performs search in the vertical direction when performing the global matching, and also performs correction to cope with the color misalignment. That is, when determining the first reference pixel, the first disparity detection section 20 searches for not only the right side pixel, whose y coordinate is the same as that of the base pixel, but also a pixel which resides at the position deviated from the base pixel in the y direction. Further, the first disparity detection section 20 uses the offset α1 for the color misalignment when calculating the DSAD. As described above, the first disparity detection section 20 is able to perform the global matching in which the accuracy is unlikely to depend on the qualities of the input images V_{L} and V_{R}. Accordingly, in the present embodiment, in most cases, the global matching has higher reliability than the local matching, and thus the region EM11 is larger than the region EM12.

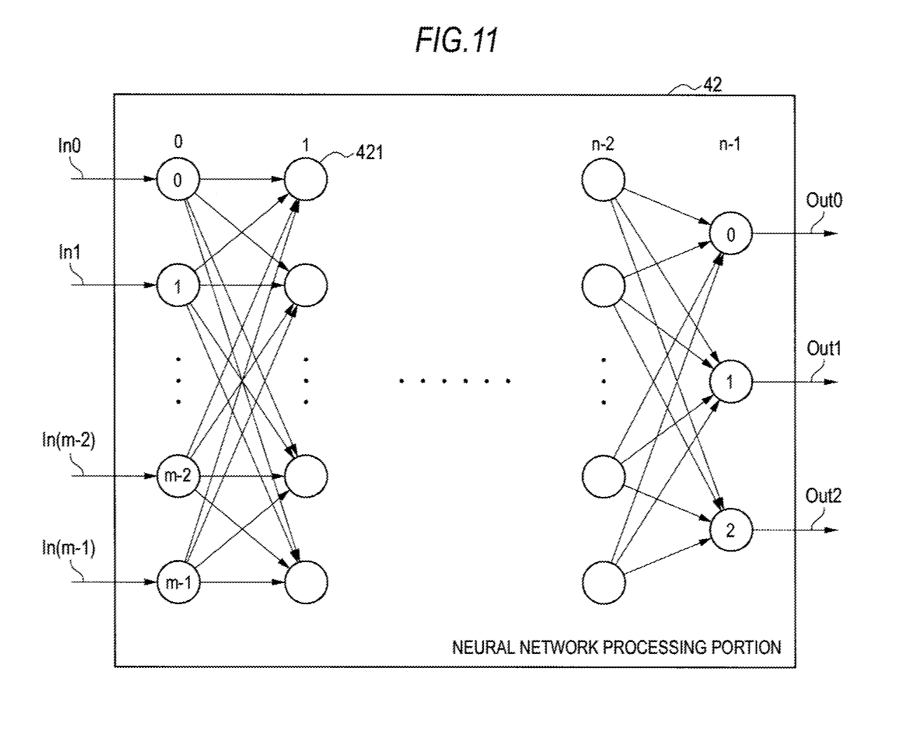

The neural network processing portion 42 has, for example, n layers as shown in FIG. 11. Here, n is an integer greater than or equal to 3. The 0th layer is an input layer, the first to (n−2)th layers are intermediate layers, and the (n−1)th layer is an output layer. Each layer has a plurality of nodes 421. That is, each of the input layer and the intermediate layers has nodes (0th to (m−1)th nodes) corresponding to the input values In0 to In(m−1). The output layer has three nodes (0th to second nodes). The output layer outputs the output values Out0 to Out2. Each node 421 is connected to all nodes 421 of a layer adjacent to the corresponding node 421. The output value from the j-th node of the k-th layer (1≦k≦n−1) is represented by, for example, the following Expression (6).

$${g}_{j}^{k} = f ( {\sum }_{i} {g}_{i}^{k - 1} {ω}_{j , i}^{k , k - 1} ) \qquad ( 6 )$$

Here, the gⱼ^{k} is an output value from the j-th node of the k-th layer, the ω_{j,i}^{k,k-1} is a propagation coefficient, the i is an integer of 0 to m−1, the gᵢ⁰ is an input value of In0 to In(m−1), the

$${\sum }_{i} {g}_{i}^{k - 1} {ω}_{j , i}^{k , k - 1}$$

is a net value of the j-th node of the k-th layer, and the f(x) is a sigmoidal function. However, when the output value is any of Out0 to Out1, the f(x) is represented by Expression (7) below. Here, the Th1 is a predetermined threshold value.

$$f ( x ) = \{ \begin{matrix}0 ( x \leq Th 1 ) \\ 1 ( x > Th 1 )\end{matrix} \qquad ( 7 )$$

Further, even when the output value is Out2 and the Out2 indicates the reliability information, the f(x) is represented by the above Expression (7).

In addition, the neural network processing portion 42 performs learning in advance in order to acquire appropriate output values Out0 to Out2. This learning is performed by, for example, back-propagation. That is, the neural network processing portion 42 updates a coefficient of propagation between the (n−2)th layer and the output layer, on the basis of the following Expressions (8) and (9).

ω′_{j,i}^{n-1,n-2}=ω_{j,i}^{n-1,n-2}+ηgᵢⁿ⁻²δⱼ (8)

δⱼ=(bⱼ−uⱼ)uⱼ(1−uⱼ) (9)

Here, the ω′_{j,i}^{n-1,n-2} is an updated value of the propagation coefficient ω′_{j,i}^{n-1,n-2}, the η is a learning coefficient (which is set in advance), the uⱼ is an output value from the j-th node of the output layer, and the bⱼ is teacher information for the uⱼ.

Then, the neural network processing portion 42 sequentially updates the propagation coefficients of the layers, which are previous to the (n−2)th layer in order from one closer to the output layer, on the basis of the following Expression (10) to (13).

$$\begin{matrix}{ω}_{j , i}^{′ k , k - 1} = {ω}_{j , i}^{k , k - 1} + η {g}_{i}^{k - 1} {δ}_{j}^{k} & ( 10 ) \\ {δ}_{j}^{k} = {g}_{j}^{k} ( 1 - {g}_{j}^{k} ) {\sum }_{i} {δ}_{i}^{k + 1} {ω}_{i , j}^{k + 1 , k} & ( 11 ) \\ {δ}_{i}^{n - 1} = {δ}_{i} & ( 12 ) \\ {δ}_{i} = ( {b}_{i} - {u}_{i} ) {u}_{i} ( 1 - {u}_{i} ) & ( 13 )\end{matrix}$$

Here, the uᵢ is an output value from the i-th node of the output layer, the bᵢ is teacher information for the uᵢ, and the ω′_{j,i}^{k,k-1} is an updated value of the propagation coefficient ω_{j,i}^{k,k-1}.

Here, as teacher information, it is possible to use a left-eye teacher image, a right-eye teacher image, a left-eye base disparity map, and a right-eye base disparity map which are provided as templates in advance. Here, the left-eye teacher image corresponds to the input image V_{L}, and the right-eye teacher image corresponds to input image V_{R}. The left-eye base disparity map is a disparity map that is created by using the left side pixels constituting the left-eye teacher image as base pixels. The right-eye base disparity map is a disparity map that is created by using the right side pixels constituting the right-eye teacher image as base pixels. That is, on the basis of such templates, the teacher information of the input values In0 to In(m−1) and the output values Out0 to Out2 are calculated. Further, on the basis of modified templates (for example, a template by which noise is added to each image, a template by which at least one of color misalignment and geometric misalignment is caused in one of the images), the teacher information of the input values In0 to In(m−1) and the output values Out0 to Out2 are calculated. The calculation of the teacher information may be performed inside the naked-eye 3D display apparatus, or may be performed in an external apparatus. Then, by sequentially providing such teacher information to the neural network processing portion 42, the neural network processing portion 42 is caused to perform learning. By causing the neural network processing portion 42 to perform such learning, it is possible to obtain the output values Out0 to Out2 less affected by color misalignment and geometric misalignment.

In addition, a user is able to modify the templates so as to obtain desired output values Out0 to Out2. That is, the relationship between the teacher information and the output values Out0 to Out2 satisfies binomial distribution, and thus a likelihood function L is given by the following Expression (14).

$$L = {\prod }_{i} {y}_{i}^{{t}_{i}} \times {( 1 - {y}_{i} )}^{( 1 - {t}_{i} )} \qquad ( 14 )$$

Here, the yᵢ is an output value of Out0 to Out2, and the tᵢ is the teacher information.

The distribution of the teacher information depends on the likelihood function L. Accordingly, it is preferable that a user modify the templates so as to maximize the likelihood at the time of obtaining the desired output values Out0 to Out2. The likelihood function L′ at the time of weighting the teacher information is given by the following Expression (15).

$$L = {\prod }_{i} {y}_{i}^{w \times {t}_{i}} \times {( 1 - {y}_{i} )}^{\overline{w} \times ( 1 - {t}_{i} )} \qquad ( 15 )$$

Here, the w and w̅ are weights.

In addition, a portion of the neural network processing portion 42 may be implemented by hardware. For example, by fixing processing from the input layer to the first layer, this portion may be implemented by hardware. Further, the feature amount calculation portion 41 and the neural network processing portion 42 may generate the output value Out1, that is, the relative reliability map in a method described below. In addition, in this processing, the neural network processing portion 42 does not perform processing using the neural network. That is, the feature amount calculation portion 41 generates a first difference map which indicates a difference between the global disparity map of the current frame and the global disparity map of the previous frame. The first difference map indicates a value which is obtained by subtracting the horizontal disparity d1 of the global disparity map of the previous frame from the horizontal disparity d1 of the global disparity map of the current frame for each left side pixel. Subsequently, the neural network processing portion 42 binarizes a first difference map, thereby generating a first binarization difference map. Then, the neural network processing portion 42 generates a first difference score map by multiplying each value of the first binarization difference map by a predetermined weight (for example 8).

Further, the feature amount calculation portion 41 generates an edge image between the global disparity map of the current frame and the input image V_{L} of the current frame, and generates a correlation map that indicates such a correlation. The edge image of the global disparity map indicates an edge portion of the global disparity map (the contour portion of each image drawn on the global disparity map). Likewise, the edge image of the input image V_{L} represents an edge portion (the contour portion of each image drawn in the input image V_{L}) of the input image V_{L}. As a method of calculating correlation between each edge images, a method of calculating a correlation relationship such as NCC is used. Then, the neural network processing portion 42 binarizes the correlation map, thereby generating a binarized correlation map. Subsequently, the neural network processing portion 42 multiplies each value of the binarized correlation map by a predetermined weight (for example 26), thereby generating a correlation score map.

Then, the neural network processing portion 42 integrates the first difference score map with the correlation score map, thereby generating a global matching reliability map through an IIR filter. A value of each left side pixel of the global matching reliability map represents a larger value between a value of the first difference score map and a value of the correlation score map.

Meanwhile, the feature amount calculation portion 41 generates a second difference map which indicates a difference between the local disparity map of the current frame and the local disparity map of the previous frame. The second difference map indicates a value which is obtained by subtracting the horizontal disparity d1 of the local disparity map of the previous frame from the horizontal disparity d1 of the local disparity map of the current frame for each left side pixel. Subsequently, the neural network processing portion 42 binarizes a second difference map, thereby generating a second binarization difference map. Then, the neural network processing portion 42 generates a second difference score map by multiplying each value of the second binarization difference map by a predetermined weight (for example 16).

Further, the feature amount calculation portion 41 generates an edge image of the input image V_{L} of the current frame. The edge image represents an edge portion (the contour portion of each image drawn in the input image V_{L}) of the input image V_{L}. The neural network processing portion 42 binarizes the edge image, thereby generating a binarized edge map. Subsequently, the neural network processing portion 42 multiplies each value of the binarized edge map by a predetermined weight (for example 8), thereby generating an edge score map.

Then, the neural network processing portion 42 integrates the second difference score map with the edge score map, thereby generating a local matching reliability map through an IIR filter. A value of each left side pixel of the local matching reliability map represents a larger value between a value of the second difference score map and a value of the edge score map.

As described above, the neural network processing portion 42 evaluates the global disparity maps by different evaluation methods, and integrates such results, thereby generating the global matching reliability map. Likewise, the neural network processing portion 42 evaluates the local disparity maps by different evaluation methods, and integrates such results, thereby generating the local matching reliability map. Here, the evaluation method of the global disparity map and the evaluation method of the local disparity map are different from each other. Further, weighting is performed differently in accordance with the evaluation method.

Then, the neural network processing portion 42 provides the global matching reliability map and the local matching reliability map, thereby determining which one is more reliable between the global disparity map and the local disparity map for each left side pixel. The neural network processing portion 42 generates the relative reliability map, which indicates a disparity map with high reliability, on the basis of the determination result.

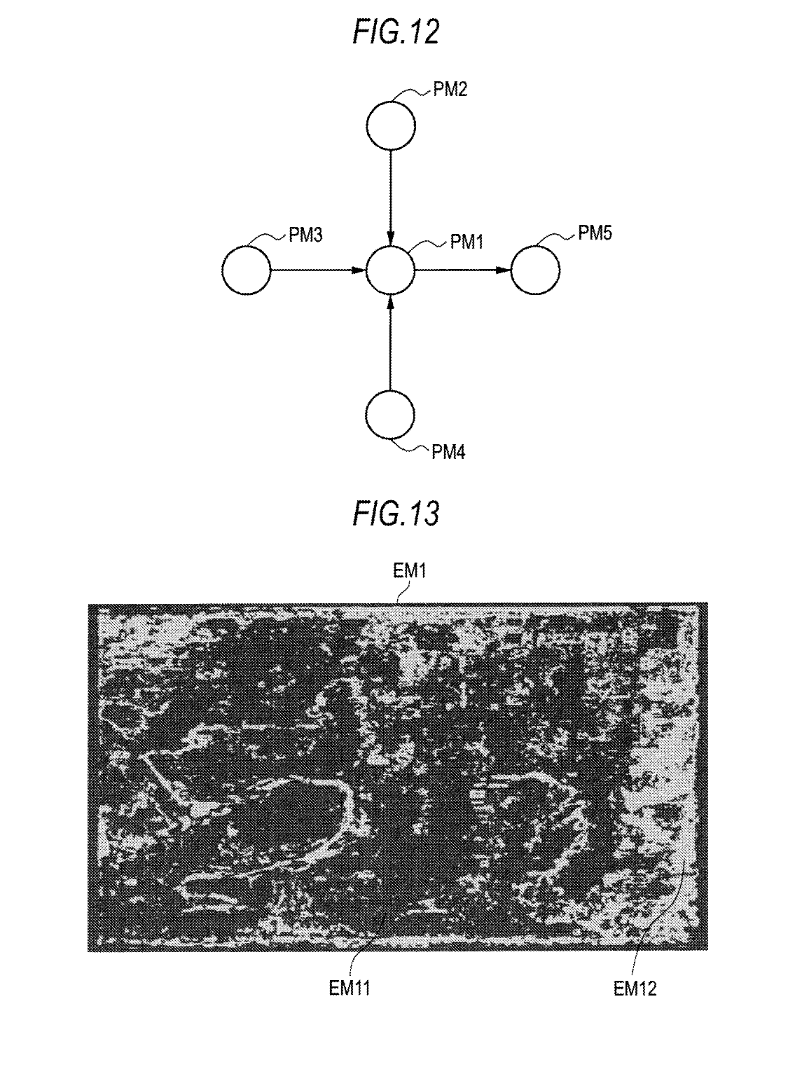

The marginalization processing portion 43 performs marginalization (smoothing) processing on each map given by the neural network processing portion 42. Specifically, the marginalization processing portion 43 sets any of pixels constituting the map as an integration base pixel, and integrates values (for example, the relative reliability, the time reliability, and the like) of the integration base pixel and the ambient pixels. The marginalization processing portion 43 normalizes the integrated value in the range of 0 to 1, and propagates the value to pixels adjacent to the integration base pixel. Here, an example of the marginalization processing will be described with reference to FIG. 12. For example, the marginalization processing portion sets the pixel PM1 as the integration base pixel, and integrates values of the integration base pixel PM1 and the ambient pixels PM2 to PM4. Then, the marginalization processing portion 43 normalizes the integrated value in the range of 0 to 1. If the value of the integration base pixel PM1 is equal to “0” or “1”, the marginalization processing portion 43 substitutes the integrated value into the above-mentioned Expression (7), thereby performing normalization. In contrast, if the value of the integration base pixel PM1 is equal to a real in the range of 0 to 1, the marginalization processing portion 43 substitutes the integrated value into the sigmoidal function, thereby performing normalization.

Then, the marginalization processing portion 43 propagates the normalized integrated value to the adjacent pixel PM5 on the right side of the integration base pixel PM1. Specifically, the marginalization processing portion 43 calculates an arithmetic mean value between the integrated value and the value of the pixel PM5, and sets the arithmetic mean value as the value of the pixel PM5. The marginalization processing portion 43 may set the integrated value to the value of the pixel PM5 as it is. In addition, when performing the marginalization processing, the marginalization processing portion 43 sets the initial value (the start point) of the integration base pixel to a pixel (pixel of x=0) at the left end of the map. In this example, the propagation direction is set as the rightward direction, but may be another direction (the leftward direction, the upward direction, or the downward direction).

The marginalization processing portion 43 may perform the marginalization processing on the entire range of the map, and may also perform the marginalization processing on a partial range. In addition, the marginalization processing of the map may be performed by a low-pass filter. However, when the marginalization processing portion 43 performs the above-mentioned processing, it is possible to obtain the following effect. That is, by using the low-pass filter, it is possible to perform the marginalization processing on only a portion of the map, in which values of pixels are greater than or equal to a predetermined value, as a target of the marginalization processing. In contrast, the marginalization processing portion 43 is able to perform the marginalization processing on the entire range or a desired range of the map. Further, since the marginalization processing using the low-pass filter merely outputs the intermediate value of each pixel, the marginalization processing is likely to cause defects in the map. For example, the feature portion of the map (for example, a portion in which an edge portion of the map or an object is drawn) is likely to be unnaturally marginalized. In contrast, since the marginalization processing portion 43 integrates values of the plurality of pixels and performs the marginalization by using the integrated value obtained in such a manner, it is possible to perform the marginalization except the feature portion of the map.

The marginalization processing portion 43 outputs the relative reliability map, which is subjected to the marginalization processing, to the map generation section 50 shown in FIG. 5. Furthermore, the marginalization processing portion 43 outputs the time reliability map, which is subjected to the marginalization processing, to the first disparity detection section 20 and the second disparity detection section 30. The time reliability map, which is output to the first disparity detection section 20 and the second disparity detection section 30, is used in the subsequent frame. Further, the marginalization processing portion 43 provides various information maps, which are subjected to the marginalization processing, to applications for which the corresponding various information maps are necessary.

### [Configuration of Map Generation Section]

The map generation section 50 generates the integral disparity map on the basis of the global disparity map, the local disparity map, and the relative reliability map. The horizontal disparity d1 and the vertical disparity d2 of the left side pixel of the integral disparity map indicate a value with higher reliability between values indicated by the global disparity map and the local disparity map. The map generation section 50 provides the integral disparity map to a multi-view image generation application in the naked-eye 3D display apparatus. Further, the map generation section 50 outputs the integral disparity map to the first disparity detection section 20. The integral disparity map, which is output to the first disparity detection section 20, is used in the subsequent frame.

Furthermore, the map generation section 50 calculates the offset α1 on the basis of the input images V_{L} and V_{R} and the integral disparity map. That is, the map generation section 50 searches the input image V_{R} for the correspondence pixels corresponding to the left side pixels on the basis of the integral disparity map. The x coordinate of each correspondence pixel is a value which is the sum of the x coordinate of the left side pixel and the horizontal disparity d1. The y coordinate of each correspondence pixel is a value which is the sum of the y coordinate of the left side pixel and the vertical disparity d2. The map generation section 50 searches for the correspondence pixel for every left side pixel.

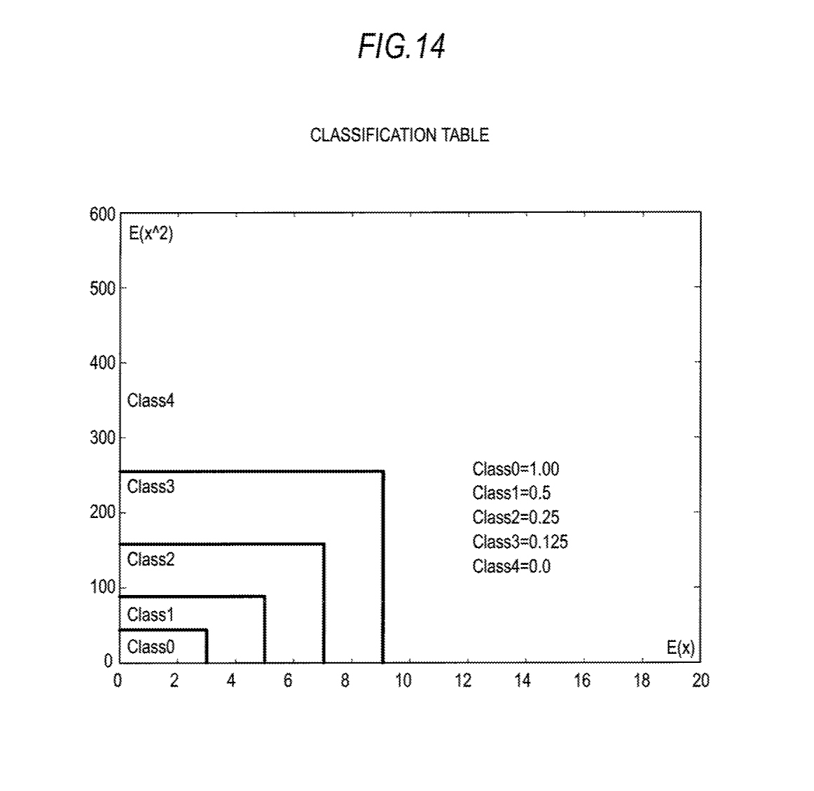

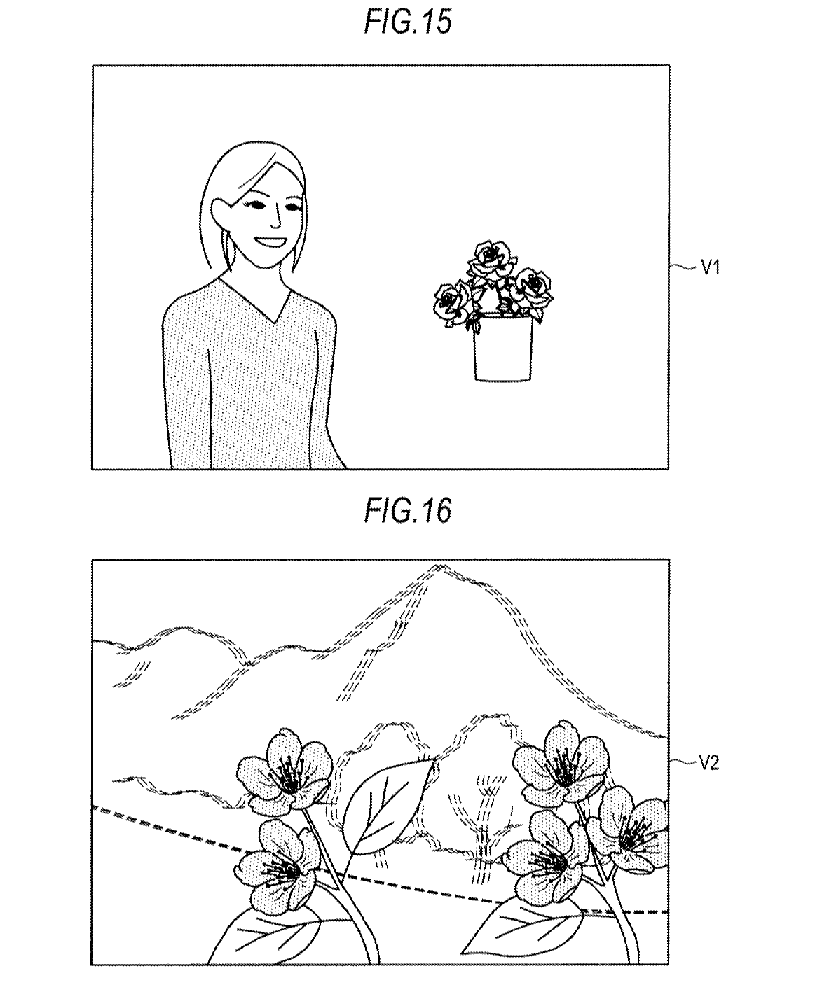

The map generation section 50 calculates luminance differences ΔLx (difference values) between the left side pixels and the correspondence pixels, and calculates an arithmetic mean value E(x) of the luminance differences ΔLx and an arithmetic mean value E(x²) of the squares of the luminance differences ΔLx. Then, the map generation section 50 determines classes of the input images V_{L} and V_{R} on the basis of the calculated arithmetic mean values E(x) and E(x²) and, for example, the classification table shown in FIG. 14. Here, the classification table indicates association of the arithmetic mean values E(x) and E(x²) and the classes of the input images V_{L} and V_{R}. The classes of the input images V_{L} and V_{R} are divided into classes 0 to 4, and each class indicates the clearness degrees of input images V_{L} and V_{R}. As the value of the class becomes smaller, the input images V_{L} and V_{R} become clearer. For example, the image V1 shown in FIG. 15 is classified as class 0. Since the image V1 is photographed at a studio, the object is drawn to be relatively clear. On the other hand, the image V2 shown in FIG. 16 is classified as class 4. Since the image V2 is photographed outdoors, a part of the object (in particular, the background part) is drawn to be relatively not clear.

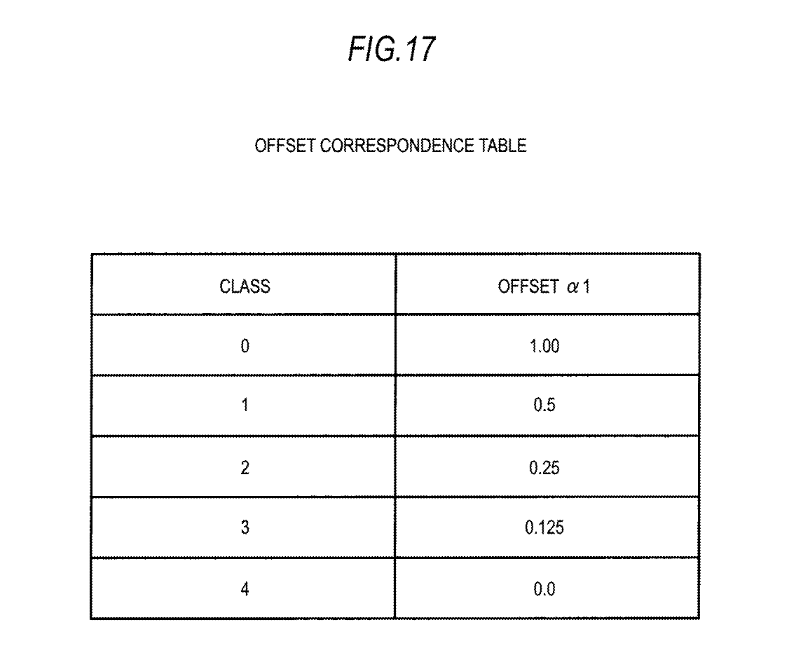

The map generation section 50 determines the offset α1 on the basis of the classes of the input images V_{L} and V_{R} and the offset correspondence table shown in FIG. 17. Here, the offset correspondence table shows a correspondence relationship between the offset α1 and the classes of the input images V_{L} and V_{R}. The map generation section 50 outputs the offset information on the determined offset α1 to the first disparity detection section 20. The offset α1 is used in the subsequent frame.

### <3. Processing Using Image Processing Device>

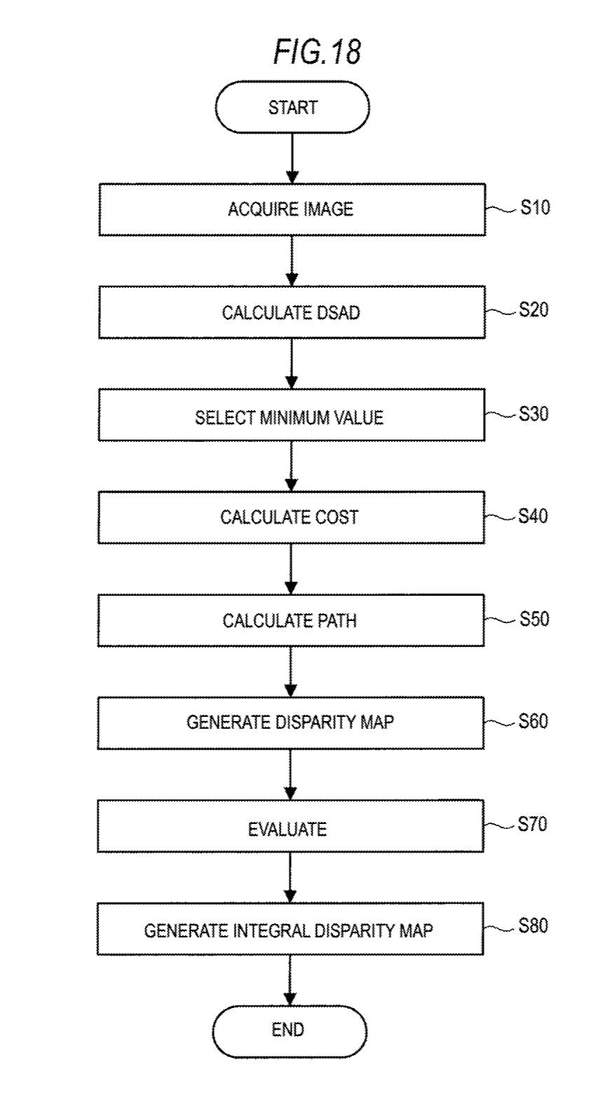

Next, the procedure of the processing using the image processing device 1 will be described with reference to a flowchart shown in FIG. 18.

In step S10, the image acquisition section 10 acquires the input images V_{L} and V_{R}, and outputs them to components of the image processing device 1. In step S20, the DSAD calculation portion 22 acquires offset information of an offset α1 from the map generation section 50. In addition, when unable to acquire the offset information (for example, when performing processing on the first frame (0th frame)), the DSAD calculation portion 22 sets the offset α1 to 0.

The DSAD calculation portion 22 acquires a global disparity map of the previous frame from the back-track portion 27. Then, the DSAD calculation portion 22 sets any one of the left side pixels as a base pixel, and searches the global disparity map of the previous frame for the horizontal disparity d1 and the vertical disparity d2 of the previous frame of the base pixel. Subsequently, the DSAD calculation portion 22 sets any one of the right side pixels, which has the vertical disparity d2 of the previous frame relative to the base pixel, as a first reference pixel. In addition, when unable to acquire the global disparity map of the previous frame (for example, when performing processing on the 0th frame), the DSAD calculation portion 22 sets the right side pixel, which has the y coordinate the same as that of the base pixel, as the first reference pixel.

Then, the DSAD calculation portion 22 sets the right side pixels, which reside in a predetermined range from the first reference pixel in the y direction, as second reference pixels. The DSAD calculation portion 22 calculates the DSAD(Δx, j) represented by the above-mentioned Expression (1) on the basis of the base pixel, the reference pixel group including the first reference pixel and the second reference pixel, and the offset α1.

The DSAD calculation portion 22 calculates the DSAD(Δx, j) for every horizontal disparity candidate Δx. Then, the DSAD calculation portion 22 changes the base pixel, and repeats the processing. Thereby, the DSAD calculation portion 22 calculates the DSAD(Δx, j) for every base pixel. Subsequently, the DSAD calculation portion 22 generates DSAD information in which each base pixel is associated with each DSAD(Δx, j), and outputs the information to the minimum value selection portion 23.

In step S30, the minimum value selection portion 23 performs the following processing, on the basis of the DSAD information. That is, the minimum value selection portion 23 selects the minimum DSAD(Δx, j) for each horizontal disparity candidate Δx. The minimum value selection portion 23 stores the selected DSAD(Δx, j) in each node P (x, Δx) of the DP map for disparity detection shown in FIG. 9.

Furthermore, the minimum value selection portion 23 specifies the reference pixel corresponding to the minimum DSAD(Δx, j) as a candidate pixel. Then, the minimum value selection portion 23 sets a value, which is obtained by subtracting the y coordinate of the base pixel from the y coordinate of the candidate pixel, as the vertical disparity candidate Δy. Subsequently, the minimum value selection portion 23 associates the horizontal disparity candidate Δx with the vertical disparity candidate Δy, and stores them in the vertical disparity candidate storage table. The minimum value selection portion 23 performs the processing for every base pixel.

In step S40, the anchor vector building portion 24 acquires the time reliability map of the previous frame from the evaluation section 40, and acquires the integral disparity map of the previous frame from the map generation section 50. The anchor vector building portion 24 specifies a disparity stabilization left side pixel on the basis of the time reliability map of the previous frame. Then, the anchor vector building portion 24 specifies, on the basis of the integral disparity map of the previous frame, the horizontal disparity d1 of the disparity stabilization left side pixel in the previous frame, that is, a stable horizontal disparity d1′. Subsequently, the anchor vector building portion 24 generates, for each disparity stabilization left side pixel, an anchor vector which is represented by the following Expression (2). In addition, when unable to acquire the time reliability map and the integral disparity map of the previous frame, the anchor vector building portion 24 sets all elements of the matrix M_{d} to 0. The anchor vector building portion 24 generates anchor vector information in which the anchor vectors are associated with the disparity stabilization left side pixels, and outputs the information to the cost calculation portion 25. Subsequently, the cost calculation portion 25 updates a value of each node P (x, d) of the DP map for disparity detection, on the basis of the anchor vector information.

In step S50, the left-eye image horizontal difference calculation portion 261 acquires the input image V_{L} from the image acquisition section 10. The left-eye image horizontal difference calculation portion 261 calculates the luminance horizontal difference dw_{L} for each left side pixel constituting the input image V_{L}, and generates luminance horizontal difference information on the luminance horizontal difference dw_{L}. Then, the left-eye image horizontal difference calculation portion 261 outputs the luminance horizontal difference information to the weight calculation portion 263.

Meanwhile, the right-eye image horizontal difference calculation portion 262 acquires the input image V_{R} from the image acquisition section 10, and performs the same processing as the above-mentioned left-eye image horizontal difference calculation portion 261 on the input image V_{R}. Then, the right-eye image horizontal difference calculation portion 262 outputs the luminance horizontal difference information, which is generated through the processing, to the weight calculation portion 263.

Subsequently, the weight calculation portion 263 calculates a weight wt_{L} of the left side pixel and a weight wt_{R} of the right side pixel for every left side pixel and right side pixel, on the basis of the luminance horizontal difference information.

Subsequently, the path calculation portion 264 calculates an accumulated cost, which is accumulated from the start point of the DP map for disparity detection to each node P (x, Δx), on the basis of the weight information given by the weight calculation portion 263.

Then, the path calculation portion 264 selects the minimum of the accumulated costs DFI(x, Δx)ₒ to DFI(x, Δx)₂ which are calculated, and sets the selected one to the accumulated cost DFI(x, Δx) of the node P (x, Δx). The path calculation portion 264 calculates the accumulated cost DFI(x, Δx) for every node P (x, Δx), and stores the cost in the DP map for disparity detection.

Subsequently, the back-track portion 27 reversely tracks a path, by which the accumulated cost is minimized, from the end point toward the start point, thereby calculating the path by which the cost, accumulated from the start point to the end point, is minimized. The node in the shortest path is the horizontal disparity d1 of the left side pixel corresponding to the node. Accordingly, the back-track portion 27 detects the respective horizontal disparities d1 of the left side pixels by calculating the shortest path.

In step S60, the back-track portion 27 acquires the vertical disparity candidate storage table corresponding to any one of the left side pixel from the vertical disparity candidate storage portion 21. The back-track portion 27 specifies the vertical disparity candidate Δy corresponding to the horizontal disparity d1 of the left side pixel on the basis of the acquired vertical disparity candidate storage table, and sets the specified vertical disparity candidate Δy as the vertical disparity d2 of the left side pixel. Thereby, the back-track portion 27 detects the vertical disparity d2. Then, the back-track portion 27 detects the vertical disparity d2 for every left side pixel, and generates the global disparity map on the basis of the detected horizontal disparity d1 and vertical disparity d2. The back-track portion 27 outputs the generated global disparity map to the DSAD calculation portion 22, and the evaluation section 40 and the map generation section 50.

Meanwhile, the second disparity detection section acquires the input images V_{L} and V_{R} from the image acquisition section 10. Further, the second disparity detection section 30 acquires the time reliability map of the previous frame from the evaluation section 40, and acquires the integral disparity map of the previous frame from the map generation section 50.

Subsequently, the second disparity detection section 30 specifies a disparity stabilization left side pixel on the basis of the time reliability map of the previous frame. Then, the second disparity detection section 30 specifies, on the basis of the integral disparity map of the previous frame, the horizontal disparity d1 and the vertical disparity d2 of the disparity stabilization left side pixel in the previous frame, that is, a stable horizontal disparity d1′ and a stable vertical disparity d2′. Subsequently, the anchor vector building portion 24 respectively adds the stable horizontal disparity d1′ and the stable vertical disparity d2′ to the xy coordinates of the disparity stabilization left side pixel, and sets the right side pixel having the xy coordinates, which is obtained in this manner, as the disparity stabilization right side pixel.

Further, the second disparity detection section 30 divides each of the input images V_{L} and V_{R} into a plurality of pixel blocks. Subsequently, the second disparity detection section 30 detects the correspondence pixels corresponding to the respective left side pixels in each left side pixel block from the right side pixel block corresponding to each left side pixel block. Here, when intending to detect the correspondence pixel corresponding to the disparity stabilization left side pixel, the second disparity detection section 30 preferentially detects the disparity stabilization right side pixel as the correspondence pixel. The second disparity detection section 30 sets a value, which is obtained by subtracting the x coordinate of the left side pixel from the x coordinate of the correspondence pixel, as the horizontal disparity d1 of the left side pixel, and sets a value, which is obtained by subtracting the y coordinate of the left side pixel from the y coordinate of the correspondence pixel, as the vertical disparity d2 of the right side pixel. The second disparity detection section 30 generates the local disparity map on the basis of the detection result. The second disparity detection section 30 outputs the generated local disparity map to the evaluation section 40.

In addition, when unable to acquire the time reliability map and the integral disparity map of the previous frame, the second disparity detection section 30 does not detect the disparity stabilization left side pixel, but performs the above-mentioned processing.

In step S70, the feature amount calculation portion 41 generates two or more feature amount maps on the basis of the disparity map and the like given by the first disparity detection section 20 and the second disparity detection section 30, and outputs the maps to the neural network processing portion 42.

Subsequently, the neural network processing portion sets any left side pixel of the left side pixels constituting each feature amount map as an evaluation target pixel, and acquires a value corresponding to the evaluation target pixel from each feature amount map. Then, the neural network processing portion 42 sets such values to input values In0 to In(m−1) of the neural network, thereby acquiring output values Out0 to Out2.

The neural network processing portion 42 generates new input values In0 to In(m−1) by sequentially changing the evaluation target pixel, and acquires output values Out0 to Out2. Thereby, the neural network processing portion 42 generates the time reliability map, the relative reliability map, and the various information maps. The neural network processing portion 42 outputs such maps to the marginalization processing portion 43.

Subsequently, the marginalization processing portion 43 performs marginalization (smoothing) processing on each map given by the neural network processing portion 42. The marginalization processing portion 43 outputs the relative reliability map, which is subjected to the marginalization processing, to the map generation section 50. Furthermore, the marginalization processing portion 43 outputs the time reliability map, which is subjected to the marginalization processing, to the first disparity detection section 20 and the second disparity detection section 30. Further, the marginalization processing portion 43 provides various information maps, which are subjected to the marginalization processing, to applications for which the corresponding various information maps are necessary.

In step S80, the map generation section 50 generates the integral disparity map on the basis of the global disparity map, the local disparity map, and the relative reliability map. The map generation section 50 provides the integral disparity map to a multi-view image generation application in the naked-eye 3D display apparatus. Further, the map generation section 50 outputs the integral disparity map to the first disparity detection section 20.

Furthermore, the map generation section 50 calculates the offset α1 on the basis of the input images V_{L} and V_{R} and the integral disparity map. That is, the map generation section 50 calculates an arithmetic mean value E(x) of the luminance differences ΔLx and an arithmetic mean value E(x²) of the squares of the luminance differences ΔLx, on the basis of the input images V_{L} and V_{R} and the integral disparity map. Then, the map generation section 50 determines classes of the input images V_{L} and V_{R} on the basis of the calculated arithmetic mean values E(x) and E(x²) and the classification table shown in FIG. 14.

Subsequently, the map generation section 50 determines the offset α1 on the basis of the classes of the input images V_{L} and V_{R} and the offset correspondence table shown in FIG. 17. The map generation section 50 outputs the offset information of the determined offset α1 to the first disparity detection section 20. Thereafter, the image processing device 1 terminates the processing.

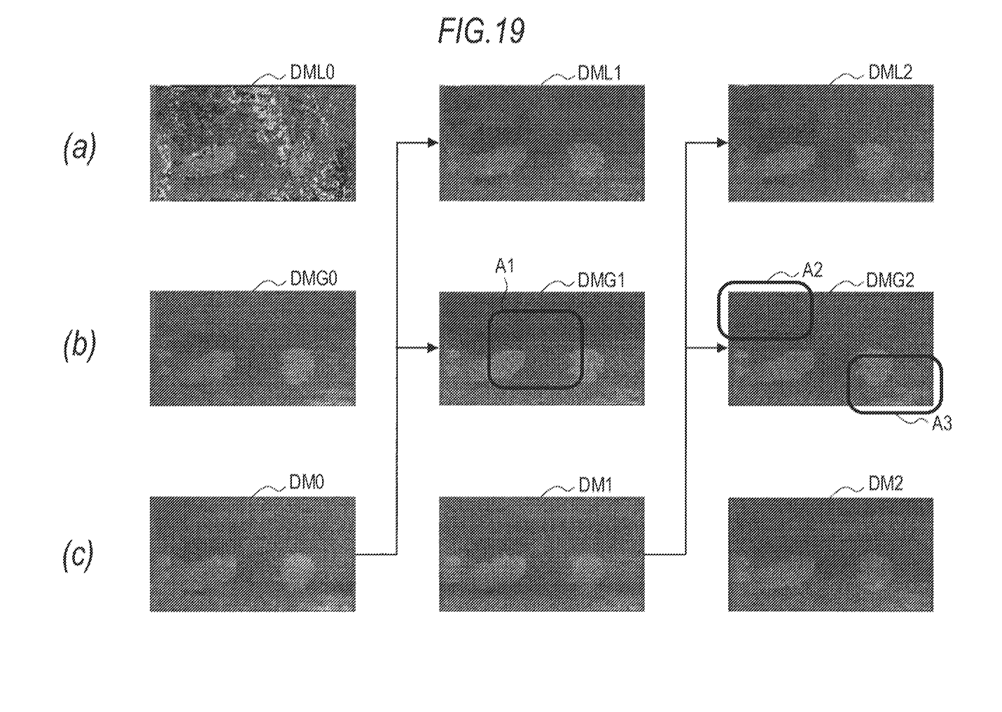

FIG. 19 illustrates situations in which the local disparity map, the global disparity map, and the integral disparity map are updated in accordance with the passage of time. (a) in FIG. 19 illustrates a situation in which the local disparity map is updated. (b) in FIG. 19 illustrates a situation in which the global disparity map is updated. (c) in FIG. 19 illustrates a situation in which the integral disparity map is updated.

In the local disparity map DML0 of the 0th frame (#0), dot noise appears. The local matching has a disadvantage in occlusion, that is, a disadvantage that stability is poor (the degree of accuracy tends to be uneven), and in the 0th frame, it is difficult to refer to the time reliability map.

Likewise, in the global disparity map DMG0 of the 0th frame, streaking (streak-like noise) appears slightly. The reason is that, in the local matching, the accuracy tends to depend on qualities of the input images V_{L} and V_{R}, and the searching range in the y direction is slightly narrower than that in the subsequent frame.

In the integral disparity map DM0 if the 0th frame (#0), the dot noise and streaking rarely appear. As described, the reason is that the integral disparity map DM0 is integrated into one of the high reliability portions of the local disparity map DML0 and the global disparity map DMG0.

In the local disparity map DML1 of the first frame (#1), dot noise rarely appears. As described above, the reason is that the second disparity detection section 30 is able to generate the local disparity map DML1 on the basis of the time reliability map and the integral disparity map of the 0th frame.

Likewise, in the global disparity map DMC1 of the first frame, streaking rarely appears. For example, streaking is reduced particularly in the region A1. The first reason is that the first disparity detection section 20 practically increases the searching range in the y direction on the basis of the global disparity map DMG0 of the 0th frame when calculating the DSAD. The second reason is that the first disparity detection section 20 preferentially selects the stable horizontal disparity d1′ of the previous frame even in the current frame.

The integral disparity map DM1 of the first frame (#1) has higher accuracy than the integral disparity map DM0 of the 0th frame. As described above, the reason is that the integral disparity map DM1 is integrated into one of the high reliability portions of the local disparity map DML1 and the global disparity map DMC1.

In the maps DML2, DMG2, and DM2 in the second frame, the result of the first frame is reflected, and thus accuracy is further improved. For example, in the regions A2 and A3 of the global disparity map DMG2, streaking is particularly reduced.

### <4. Effect of Image Processing Device>

Next, an effect of the image processing device 1 will be described. Further, the image processing device 1 detects the candidate pixel as a candidate of the correspondence pixel from the reference pixel group including the first reference pixel, which constitutes the input image V_{R}, and the second reference pixel whose vertical position is different from that of the first reference pixel. Then the image processing device 1 stores the vertical disparity candidate Δy, which indicates a distance from the vertical position of the base pixel to the vertical position of the candidate pixel, in the vertical disparity candidate storage table.

As described above, the image processing device 1 searches for the candidate pixel as a candidate of the correspondence pixel in the vertical direction (y direction), and stores the vertical disparity candidate Δy as a result thereof in the vertical disparity candidate storage table. Accordingly, the image processing device 1 is able to search for not only the right side pixel whose vertical position is the same as that of the base pixel but also the right side pixel whose vertical position is different from that of the base pixel. Thus, it is possible to detect the horizontal disparity with high robustness and accuracy.

Further, in the image processing device 1, a pixel in a predetermined range from the first reference pixel in a vertical direction is included as the second reference pixel in the reference pixel group. Therefore, it is possible to prevent the searching range in the y direction from being excessively increased. That is, the image processing device 1 is able to prevent an optimization problem from arising.

Furthermore, the image processing device 1 generates the reference pixel group for each first reference pixel whose horizontal position is different, and associates the vertical disparity candidate Δy with the horizontal disparity candidate Δx, and stores them in the vertical disparity candidate storage table. Thereby, the image processing device 1 is able to generate the vertical disparity candidate storage table with higher accuracy.

As described above, the image processing device 1 compares the input images V_{L} and V_{R} (that is, performs the matching processing), and thereby stores the vertical disparity candidate Δy in the vertical disparity candidate storage table. However, the image processing device 1 stores the vertical disparity candidate Δy in the vertical disparity candidate storage table once, and thereafter performs calculation of the shortest path and the like, thereby detecting the horizontal disparity d1. That is, since the image processing device 1 detects the horizontal disparity d1 by performing the matching processing once, it is possible to promptly detect the horizontal disparity d1.

Then, the image processing device 1 detects the vertical disparity candidate Δy, which corresponds to the horizontal disparity d1, as the vertical disparity d2 of the base pixel, among the vertical disparity candidates Δy stored in the vertical disparity candidate storage table. Thereby, the image processing device 1 is able to detect the vertical disparity d2 with high accuracy. That is, the image processing device 1 is able to perform disparity detection less affected by the geometric misalignment.

Further, the image processing device 1 sets a pixel, which has the vertical disparity d2 detected in the previous frame, among right side pixels of the current frame, as the first reference pixel of the current frame with respect to the base pixel of the current frame. Thereby, the image processing device 1 is able to update the first reference pixel, and is able to form the reference pixel group on the basis of the first reference pixel. Accordingly, the image processing device 1 is able to practically increase the searching range for the candidate pixel.

Furthermore, the image processing device 1 calculates the DSAD(Δx, j) on the basis of the luminance difference ΔLx between the input images V_{L} and V_{R}, that is, the offset α1 corresponding to the color misalignment, and detects the candidate pixel on the basis of the DSAD(Δx, j). Accordingly, the image processing device 1 is able to perform disparity detection less affected by the color misalignment.

Further, the image processing device 1 calculates the DSAD(Δx, j) on the basis of not only the base pixel, the first reference pixel, and the second reference pixel, but also the luminances of ambient pixels of such pixels. Therefore, it is possible to calculate the DSAD(Δx, j) with high accuracy. In particular, the image processing device 1 calculates the DSAD(Δx, j) on the basis of the luminance of the pixel which resides at a position deviated in the y direction with respect to the base pixel, the first reference pixel, and the second reference pixel. In this regard, it is possible to perform disparity detection less affected by the geometric misalignment.

Furthermore, the image processing device 1 calculates the offset α1 on the basis of the luminance difference ΔLx and the square of the luminance difference ΔLx of the input images V_{L} and V_{R}. Therefore, it is possible to calculate the offset α1 with high accuracy. In particular, the image processing device 1 calculates the luminance difference ΔLx and the square of the luminance difference ΔLx for each left side pixel, thereby calculating the arithmetic mean values E(x) and E(x²) thereof. Then, the image processing device 1 calculates the offset α1 on the basis of the arithmetic mean values E(x) and E(x²). Thus, it is possible to calculate the offset α1 with high accuracy.

In particular, the image processing device 1 determines the classes of the input images V_{L} and V_{R} of the previous frame on the basis of the classification table, and calculates the offset α1 on the basis of the classes of the input images V_{L} and V_{R} of the previous frame. The classes indicate the clearness degrees of the input images V_{L} and V_{R}. Accordingly, the image processing device 1 is able to calculate the offset α1 with higher accuracy.

Further, the image processing device 1 calculates various feature amount maps, and sets the values of the feature amount maps to the input values In0 to In(m−1) of the neural network processing portion 42. Then, the image processing device 1 calculates the relative reliability, which indicates a more reliable map of the global disparity map and the local disparity map, as the output value Out1. Thereby, the image processing device 1 is able to perform disparity detection with higher accuracy. That is, the image processing device 1 is able to generate the integral disparity map in which high reliability portions of such maps are integrated.

Further, the image processing device 1 calculates the output values Out0 to Out2 through the neural network. Therefore, the accuracies of the output values Out0 to Out2 are improved. Furthermore, there is improvement in the maintenance of the neural network processing portion 42 (that is, it becomes easy to perform the maintenance). Moreover, connections between the nodes 421 are complex, and thus the number of combinations of the nodes 421 is huge. Accordingly, the image processing device 1 is able to improve the accuracy of the relative reliability.

Further, the image processing device 1 calculates the time reliability, which indicates whether or not the integral disparity map can be used as a reference in the subsequent frame, as the output value Out0. Accordingly, the image processing device 1 is able to perform the disparity detection in the subsequent frame on the basis of the time reliability. Thereby, the image processing device 1 is able to perform disparity detection with higher accuracy. Specifically, the image processing device 1 generates the time reliability map which indicates the time reliability for each left side pixel. Accordingly, the image processing device 1 is able to preferentially select the disparity with high time reliability between the horizontal disparity d1 and the vertical disparity d2 of each left side pixel indicated by the integral disparity map, even in the subsequent frame.

Furthermore, the image processing device 1 sets the DSAD as the score of the DP map for disparity detection. Therefore, compared with the case where only the SAD is set as the score, it is possible to calculate the score of the DP map for disparity detection with high accuracy. Consequently, it is possible to perform disparity detection with high accuracy.

In addition, the image processing device 1 calculates the accumulated cost of each node P (x, d) in consideration of the weights wt_{L} and wt_{R} corresponding to the horizontal difference. Therefore, it is possible to calculate the accumulated cost with high accuracy. The weights wt_{L} and wt_{R} are small at the edge portion, and large at the planar portion. Therefore, smoothing is appropriately performed in accordance with an image.

Further, the image processing device 1 generates the correlation map which indicates a correlation between edge images of the global disparity map and the input image V_{L}, and calculates the reliability of the global disparity map on the basis of the correlation map. Accordingly, the image processing device 1 is able to calculate the reliability of the so-called streaking region of the global disparity map. Hence, the image processing device 1 is able to perform disparity detection with high accuracy in the streaking region.

Furthermore, the image processing device 1 evaluates the global disparity map and the local disparity map in mutually different evaluation methods when evaluating the global disparity map and the local disparity map. Therefore, it is possible to perform evaluation in consideration of such a characteristic.

In addition, the image processing device 1 applies the IIR filter to the map which is obtained by each evaluation method so as to thereby generate the global matching reliability map and the local matching reliability map. Therefore, it is possible to generate the reliability map which is stable in terms of time.

Further, the image processing device 1 generates the integral disparity map by employing the more reliable of the global disparity map and the local disparity map. Accordingly, the image processing device 1 is able to detect the accurate disparity in the region in which the disparity is unlikely to be detected in the global matching, and in the region in which the disparity is unlikely to be detected in the local matching.

Further, the image processing device 1 considers the generated integral disparity map in the subsequent frame. Therefore, compared with the case where a plurality of matching methods are performed in parallel, it is possible to perform disparity detection with high accuracy.

As described above, the preferred embodiments of the present disclosure were described in detail with reference to the accompanying drawings. However, the present disclosure is not limited to the corresponding examples. It will be readily apparent to those skilled in the art that obvious modifications, derivations, and variations can be made without departing from the technical scope described in the claims appended hereto. In addition, it should be understood that such modifications, derivations, and variations belong to the technical scope of the present disclosure.

In addition, the following configurations also belong to the technical scope of the present disclosure.

(1) An image processing device including:

an image acquisition section that acquires a base image and a reference image in which a same object is drawn at horizontal positions different from each other; and

a disparity detection section that detects a candidate pixel as a candidate of a correspondence pixel corresponding to a base pixel, which constitutes the base image, from a reference pixel group including a first reference pixel, which constitutes the reference image, and a second reference pixel, whose vertical position is different from that of the first reference pixel, on the basis of the base pixel and the reference pixel group, associates a horizontal disparity candidate, which indicates a distance from a horizontal position of the base pixel to a horizontal position of the candidate pixel, with a vertical disparity candidate, which indicates a distance from a vertical position of the base pixel to a vertical position of the candidate pixel, and stores the associated candidates in a storage section.

(2) The image processing device according to (1) described above, wherein in the disparity detection section, a pixel in a predetermined range from the first reference pixel in a vertical direction is included as the second reference pixel in the reference pixel group.

(3) The image processing device according to (1) or (2) described above, wherein the disparity detection section detects a horizontal disparity of the base pixel from a plurality of the horizontal disparity candidates, and detects a vertical disparity candidate, which corresponds to the horizontal disparity, as a vertical disparity of the base pixel, among the vertical disparity candidates stored in the vertical disparity candidate storage table.

(4) The image processing device according to (3) described above, wherein the disparity detection section sets a pixel, which has the vertical disparity detected in a previous frame, among pixels constituting the reference image of a current frame, as the first reference pixel of the current frame with respect to the base pixel of the current frame.

(5) The image processing device according to any one of (1) to (4) described above, further including an offset calculation section that calculates an offset corresponding to a difference value between feature amounts of the base pixel and the correspondence pixel of the previous frame,

wherein the disparity detection section calculates a first evaluation value on the basis of a base pixel feature amount in a base region including the base pixel, a first reference pixel feature amount in a first reference region including the first reference pixel, and the offset, calculates a second evaluation value on the basis of the base pixel feature amount, a second reference pixel feature amount in a second reference region including the second reference pixel, and the offset, and detects the candidate pixel on the basis of the first evaluation value and the second evaluation value.

(6) The image processing device according to (5) described above, wherein the offset calculation section calculates the offset on the basis of the difference value and a square of the difference value.

(7) The image processing device according to (6) described above, wherein the offset calculation section determines classes of the base image and the reference image of the previous frame on the basis of a mean value of the difference values, a mean value of the square of the difference values, and a classification table which indicates the classes of the base image and the reference image in association with each other, and calculates the offset on the basis of the classes of the base image and the reference image of the previous frame.

(8) The image processing device according to any one of (1) to (7) described above, further including:

a second disparity detection section that detects at least the horizontal disparity of the base pixel by using a method different from a first disparity detection section which is the disparity detection section; and

an evaluation section that inputs an arithmetic feature amount, which is calculated on the basis of the base image and the reference image, to a neural network so as to thereby acquire relative reliability, which indicates a more reliable detection result between a detection result obtained by the first disparity detection section and a detection result obtained by the second disparity detection section, as an output value of the neural network.

(9) The image processing device according to (8) described above, wherein the evaluation section acquires time reliability, which indicates whether or not it is possible to refer to the more reliable detection result in a subsequent frame, as the output value of the neural network.

(10) An image processing method including:

acquiring a base image and a reference image in which a same object is drawn at horizontal positions different from each other; and

detecting a candidate pixel as a candidate of a correspondence pixel corresponding to a base pixel, which constitutes the base image, from a reference pixel group including a first reference pixel, which constitutes the reference image, and a second reference pixel, whose vertical position is different from that of the first reference pixel, on the basis of the base pixel and the reference pixel group, associating a horizontal disparity candidate, which indicates a distance from a horizontal position of the base pixel to a horizontal position of the candidate pixel, with a vertical disparity candidate, which indicates a distance from a vertical position of the base pixel to a vertical position of the candidate pixel, and storing the associated candidates in a storage section.

(11) A program for causing a computer to execute:

an image acquisition function that acquires a base image and a reference image in which a same object is drawn at horizontal positions different from each other; and

a disparity detection function that detects a candidate pixel as a candidate of a correspondence pixel corresponding to a base pixel, which constitutes the base image, from a reference pixel group including a first reference pixel, which constitutes the reference image, and a second reference pixel, whose vertical position is different from that of the first reference pixel, on the basis of the base pixel and the reference pixel group, associates a horizontal disparity candidate, which indicates a distance from a horizontal position of the base pixel to a horizontal position of the candidate pixel, with a vertical disparity candidate, which indicates a distance from a vertical position of the base pixel to a vertical position of the candidate pixel, and stores the associated candidates in a storage section.

The present disclosure contains subject matter related to that disclosed in Japanese Priority Patent Application JP 2011-214673 filed in the Japan Patent Office on Sep. 29, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device comprising:
an image acquisition section that acquires a base image and a reference image in which a same object is drawn at horizontal positions different from each other; and
a disparity detection section that detects a candidate pixel as a candidate of a correspondence pixel corresponding to a base pixel, which constitutes the base image, from a reference pixel group including a first reference pixel, which constitutes the reference image, and a second reference pixel, whose vertical position is different from that of the first reference pixel, on the basis of the base pixel and the reference pixel group, associates a horizontal disparity candidate, which indicates a distance from a horizontal position of the base pixel to a horizontal position of the candidate pixel, with a vertical disparity candidate, which indicates a distance from a vertical position of the base pixel to a vertical position of the candidate pixel, and stores the associated candidates in a storage section.

2. The image processing device according to claim 1, wherein in the disparity detection section, a pixel in a predetermined range from the first reference pixel in a vertical direction is included as the second reference pixel in the reference pixel group.

3. The image processing device according to claim 1, wherein the disparity detection section detects a horizontal disparity of the base pixel from a plurality of the horizontal disparity candidates, and detects a vertical disparity candidate, which corresponds to the horizontal disparity, as a vertical disparity of the base pixel, among the vertical disparity candidates stored in the storage section.

4. The image processing device according to claim 3, wherein the disparity detection section sets a pixel, which has the vertical disparity detected at a previous frame, among pixels constituting the reference image of a current frame, as the first reference pixel of the current frame with respect to the base pixel of the current frame.

5. The image processing device according to claim 1, further comprising an offset calculation section that calculates an offset corresponding to a difference value between feature amounts of the base pixel and the correspondence pixel of the previous frame,
wherein the disparity detection section calculates a first evaluation value on the basis of a base pixel feature amount in a base region including the base pixel, a first reference pixel feature amount in a first reference region including the first reference pixel, and the offset, calculates a second evaluation value on the basis of the base pixel feature amount, a second reference pixel feature amount in a second reference region including the second reference pixel, and the offset, and detects the candidate pixel on the basis of the first evaluation value and the second evaluation value.

6. The image processing device according to claim 5, wherein the offset calculation section calculates the offset on the basis of the difference value and a square of the difference value.

7. The image processing device according to claim 6, wherein the offset calculation section determines classes of the base image and the reference image of the previous frame on the basis of a mean value of the difference values, a mean value of the square of the difference values, and a classification table which indicates the classes of the base image and the reference image in association with each other, and calculates the offset on the basis of the classes of the base image and the reference image of the previous frame.

8. The image processing device according to claim 1, further comprising:
a second disparity detection section that detects at least the horizontal disparity of the base pixel by using a method different from a first disparity detection section which is the disparity detection section; and
an evaluation section that inputs an arithmetic feature amount, which is calculated on the basis of the base image and the reference image, to a neural network so as to thereby acquire relative reliability, which indicates a more reliable detection result between a detection result obtained by the first disparity detection section and a detection result obtained by the second disparity detection section, as an output value of the neural network.

9. The image processing device according to claim 8, wherein the evaluation section acquires time reliability, which indicates whether or not it is possible to refer to the more reliable detection result in a subsequent frame, as the output value of the neural network.

10. An image processing method comprising:
acquiring a base image and a reference image in which a same object is drawn at horizontal positions different from each other; and
detecting a candidate pixel as a candidate of a correspondence pixel corresponding to a base pixel, which constitutes the base image, from a reference pixel group including a first reference pixel, which constitutes the reference image, and a second reference pixel, whose vertical position is different from that of the first reference pixel, on the basis of the base pixel and the reference pixel group, associating a horizontal disparity candidate, which indicates a distance from a horizontal position of the base pixel to a horizontal position of the candidate pixel, with a vertical disparity candidate, which indicates a distance from a vertical position of the base pixel to a vertical position of the candidate pixel, and storing the associated candidates in a storage section.

11. A program for causing a computer to execute functions of:
acquiring a base image and a reference image in which a same object is drawn at horizontal positions different from each other; and
detecting a candidate pixel as a candidate of a correspondence pixel corresponding to a base pixel, which constitutes the base image, from a reference pixel group including a first reference pixel, which constitutes the reference image, and a second reference pixel, whose vertical position is different from that of the first reference pixel, on the basis of the base pixel and the reference pixel group, associating a horizontal disparity candidate, which indicates a distance from a horizontal position of the base pixel to a horizontal position of the candidate pixel, with a vertical disparity candidate, which indicates a distance from a vertical position of the base pixel to a vertical position of the candidate pixel, and storing the associated candidates in a storage section.
